(19) United States
(12) Patent Application Publication
(10) Pub. No.: US 2006/0179065 A1
(43) Pub. Date: Aug. 10, 2006

(54) Matrix oriented application framework with interchangeable data source mapping and user interface

(76) Inventor: Jordan Jianping Xu, Washington, DC (US)

Correspondence Address: GREENBLUM & BERNSTEIN, P.L.C., 1950 Roland Clarke Place, Reston, VA, 20191, US

(21) Appl. No.: 11/049,712

(22) Filed: Feb. 4, 2005

(51) Int. Cl. G06F 7/00

(52) U.S. Cl. 707/100

(57) ABSTRACT

An application framework that includes modular components is disclosed that simplifies development of web-based applications. The application framework may be written in Java based on servlet/JSP. Through the use of components that include at least a data model object, a view object, and a data storage object, the application framework can be reconfigured to retrieve and display any number of data fields without changing the underlying user-interface code. The data model object provides a standardized matrix of data objects, which are used to map data from virtually any data source to the user interface. The view object takes data from the data model object and presents it for display. The data storage object enables CREATE, READ, UPDATE, and DELETE operations related to data access. The data storage object maps data from data storage to the data model object in an order specified by the data model object.

### FIELD OF THE INVENTION

The invention relates generally to standardized user interface and data access modules for software applications, more particularly, to independent, functionally complete software components that make it possible to change data sources and user interfaces without modifying application code.

### BACKGROUND DESCRIPTION

Maximum reusability, or the maximum ability to write generic software code that can be reused in many types of application programs, has been a significant goal in the software development community for a long time. Although object-oriented programming languages such as C++ and Java enable developers to write code that encapsulates the behaviors and attributes of objects in the physical world, large-scale reusability remains difficult to achieve.

This is especially true where databases and user interfaces are concerned. In the computer environment, a database is a file or set of files (e.g., a container) in which collections of data are stored in an organized fashion. A Database Management System (DBMS) is software used to create databases and to manipulate data within them. Typically, this is accomplished using a component of the DBMS called a User Interface (UI) that enables the visible display of portions of the stored data.

Within a database, data is stored in specific files called tables. Tables are software files that are structured to store data of a specific type. Illustratively, a table might contain a list of telephone numbers, Uniform Resource Locators (URLs), or any other list of information. Unique names are given both to the database and to each table stored within it. Tables are described by a set of information called a schema, which determines how data is stored in the table. A schema may be used to describe specific tables, relationships among tables in a database, or an entire database itself.

Tables are formed of columns. Each column corresponds to a single field, and has a datatype associated therewith. A specific piece of data is stored in each column. The datatype defines what type of data (e.g., text, numbers, dates, etc.) the column can contain. A datatype can function to restrict certain types of data from being stored in a column. For example, entry of alphanumeric data into a column having a numeric datatype would not be allowed. Datatypes and their names are one of the reasons software developers hand-code when customizing UI's. Although many basic types of datatypes are standardized, many advanced datatypes are not. Additionally, different DBMS' may refer to the same datatype differently.

Storage of data in a table is accomplished using rows. Each row corresponds to one data record. Thus, the number of rows in the table equals the number of records stored therein. Although not required, tables may be constructed such that each row has a column (or set of columns) that uniquely identifies it. Such a column is called a primary key. Illustratively, in a table of email addresses, the user name column might be used to refer to a particular record (e.g., single row).

Data in a database can be accessed in various ways. Conventionally, a platform independent, open-source programming language called Structured Query Language (SQL) has been used. Because SQL is not proprietary, it is supported by most database vendors, and is thus capable of interacting with virtually all known types of databases. SQL is another reason software developers hand-code when customizing a business application program. For example, many DBMS vendors support SQL by adding unique statements or instructions to the language. Although useful, these extensions tend to be DBMS specific, and are usually not supported by other vendors. Standard SQL conforms to standards promulgated by the American National Standards Institute (ANSI) and is called ANSI SQL. Other variations have their own names, such as MY SQL, PL-SQL, etc.

The business software world is rapidly moving from bulky one-size-fits-all application programs to custom-tailored business application programs that are light and nimble. Thus, in today's application development environment, most of the efforts are spent on querying data from data providers (e.g., database servers or legacy servers) and presenting the data on a UI properly. However, no software tools exist to automate this process because, as mentioned above, database configurations vary widely from one data storage provider to another. These individual variations mean that the section(s) of the UI's code that access data must be amended or revised by hand. Hand revisions, however, often prove cumbersome, especially where many pages of UI code have to be modified and/or re-written. Another disadvantage is that the hand-coding process tends to be repeated, often at substantial expense, every time a new version of software is released, because customized software can only be upgraded by customizing the recently released version of software. Thus, it is not uncommon for the cost of customizing and deploying an enterprise-level application program to run into the millions of dollars. A solution is needed to enable construction of independent, interchangeable data storage objects and UI modules, which can be assembled into different applications with little or no code changes.

### SUMMARY OF THE INVENTION

The invention meets the foregoing needs and avoids these and other drawbacks and disadvantages of the prior art by providing an application framework that includes a data model and a data storage object, which interact together and with a UI and a data storage to map data retrieved from the data storage to the UI in a manner that permits the UI to access differently configured data storages without the need to hand-edit the UI code. The application framework may include a web-application framework or a desktop-application framework.

An application framework constructed according to the principles of the invention may include a view object configured to display data on a user interface. The view object may interact with an underlying data model object. The data model object may be configured to provide a standardized matrix of data objects, accessible by the view object, into which the data to be displayed on the user interface is mapped. The data model object may interact with a data storage object configured to retrieve the user interface data from a data storage. The data storage object may be further configured to map the data to the standardized matrix provided by the data model object.

In one embodiment, a key tag, whose value is set at run-time, may be used to designate the data that is mapped to the data model. One or more of the data objects contained within the standardized matrix provided by the data model may include another standardized matrix of data objects. One or more of the data objects may be configured to display text, picture, video, and/or audio file(s). The data storage may include one or more data containers, one or more of which may be stored on separate servers or drives. Each data container may illustratively include at least one of the following types of data access components, including but not limited to, a file system, an email server, a LDAP server, a relational database, an EJB server, a service oriented server, etc. A data access component need not actually store data, but may be configured to retrieve data from another source. Additionally, the data model object may include one or more action objects, such as, but not limited to, a login object, a validator object, and a transformer object.

The invention may further include one or more processes. An exemplary process may include receiving user input and requesting one or more pieces of data; accessing a data storage to retrieve the requested one or more pieces of data; and mapping the retrieved, requested one or more pieces of data to a standardized matrix of data objects independent of a type of data storage accessed.

Additional features, advantages and embodiments of the invention may be set forth in the following detailed description, drawings, and claims, including methods of using the invention to enable construction of independent, interchangeable data storage objects and UI modules, which can be assembled into different applications with little or no code changes. Although numerous implementations and examples of the invention are set forth, the examples and implementations are not intended to limit the scope of the invention.

### BRIEF DESCRIPTION OF THE DRAWINGS

The accompanying drawings, which are included to provide a further understanding of the invention and which are incorporated in and constitute part of this specification, illustrate embodiments of the invention. Together with the detailed description, the drawings serve to explain principles of the invention.

FIG. 1A is a diagram of a conventional computer usable with embodiments of the invention.

FIG. 1B is a diagram of a conventional computer network usable with embodiments of the invention.

FIG. 1C is a diagram of a conventional web-based Java application.

FIG. 2 is a diagram illustrating the relationship between elements displayed in a user interface and data stored in a data source, such as a database.

FIG. 3 is a diagram of an inventive software component that is independent of a data provider and which is used to create a direct channel between a user interface and data stored in a data storage system.

FIG. 4 is a diagram illustrating various views associated with the inventive software component of FIG. 3.

FIG. 5A is a diagram illustrating a relationship between a user-interface and a customized server-side presentation logic.

FIG. 5B is a diagram illustrating how a view interacts with a data model object.

FIG. 6 is a diagram illustrating how the various views of FIG. 4 relate data stored in a database.

FIG. 7 is a diagram illustrating an application framework designed to tie the inventive software components and other components together to make a single application.

FIG. 8 is a diagram illustrating one embodiment of a notes table.

FIG. 9 is a diagram of one embodiment of a login interface.

FIG. 10 is a diagram of one embodiment of a member list page.

FIG. 11 is a diagram of an embodiment of a notes page.

FIG. 12 illustrates how an update component might look when viewed in a User Interface.

FIG. 13 is a diagram of one embodiment of a user_info table.

FIG. 14 is a diagram of one embodiment of an event-id_destination page table.

FIG. 15 is a diagram of one embodiment of a client_info table.

FIG. 16 is a representative table generated by an exemplary method in accordance with the invention.

### DETAILED DESCRIPTION OF THE INVENTION

The invention is directed to a data model and an underlying data storage object that permits data from data sources having different configurations to be accessed by a User Interface (UI) with minimal or no hand-coding.

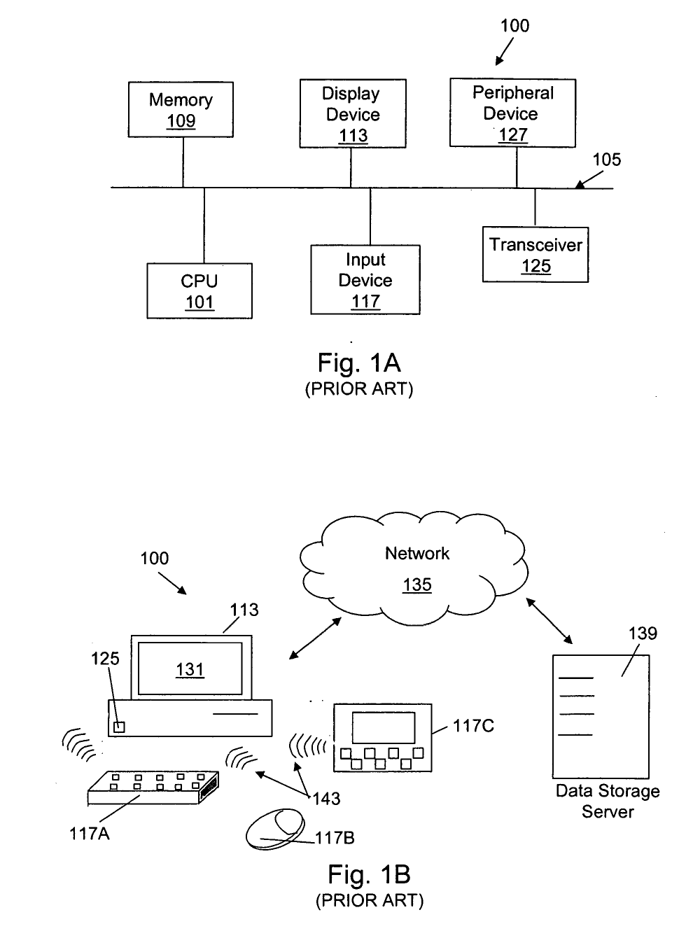

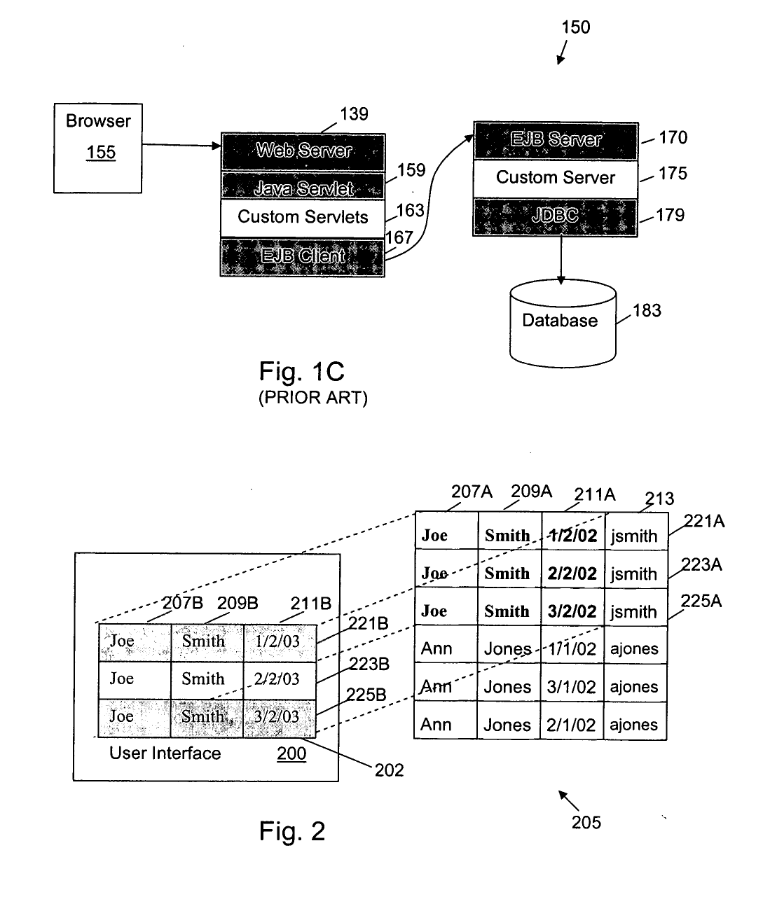

FIG. 1A is a diagram of a conventional computer 100 usable with embodiments of the invention. Computer 100 includes a central processing unit (CPU) 101 connected via a bus 105 to memory 109, display device 113, input device 117, peripheral device 127, and transceiver 125. Computer executable instructions (e.g., software code) are stored in memory 109, which may be a hard disk, flash memory, random access memory (RAM), or other type of memory device. These instructions, when executed by the CPU 101 cause the computer 100 to perform various actions such as sending/receiving data to/from a peripheral device such as a laser printer or a personal data assistant (PDA), storing data in a database; displaying data retrieved from a database on a display device 113; and processing input received from various input devices 117, such as a mouse and keyboard.

FIG. 1B is a diagram of a computer 100 configured as shown in FIG. 1 and connected to a data storage server 139 over a network 135, which may be a local-area network (LAN), a wide area network (WAN), or the Internet. The computer 100 receives input from input devices 117A, 117B, 117C which are a keyboard, a mouse, and a PDA, respectively, over one or more communications channels 143. These channels may be hard-wired via metal or optical cables or may be wireless. Where wireless channels 143 are used, packetized radio signals are transmitted between the computer 100 and one or more peripheral devices 117A, 117B, and 117C via the computer 100's transceiver 125. In this manner, computer 100 may be used to access, store, delete, or manipulate data in databases that reside within its own memory, within the memory of the PDA 117C, and/or within the memory of the data storage server 139. The graphical user interface 131 visibly displayed on the computer display device 113 (e.g., plasma display, liquid crystal display, or cathode ray tube device) presents a visual depiction of the data stored in memory 109, PDA 117C, and/or data storage server 139, and may be customized to fit a particular design requirement. The graphical user interface 131 may take the form of an internet browser program 155 (shown in FIG. 1C).

FIG. 1C is a diagram of a conventional web-based Java application 150 that resides on a database (or web) server 139. A UI such as an internet browser 155 may be used to access and run the Java application 150. The Java Programming Language (JPL) standardizes development and deployment of secure, portable, reliable, and scalable applications. Application programs created with JPL can run in the browser 155, from a desktop/notebook computer 100, on a server 139, or on a consumer device, such as the PDA 117C. Java programs interpreted by another program called the Java Virtual Machine (Java VM). Rather than running directly on the native operating system, the program is interpreted by the Java VM for the native operating system. This means that any computer system with the Java VM installed can run a Java program regardless of the computer system on which the application was originally developed.

Within the data storage server 139, the Java Servlet Engine 159 is used to run custom-created servlets 163. Java servlets, which can almost be thought of as server-side applets, are automated portions of code that make many Web applications possible. Servlets 163 are custom-created to tailor them to a particular data source. An Enterprise JavaBeans (EJB) client 167 communicates with an EJB server 170 to provide data from the database 183 to the browser 155. A custom server 175 having the same schema as the database 183 is provided to enable access to the database 183. A Java Database Connectivity (JDBC) module 179 is also provided. JDBC is a Java Application Program Interface (API) that enables Java programs to execute SQL statements. This allows Java programs to interact with any SQL-compliant database 183. Since nearly all relational DBMSs support SQL, and because Java itself runs on most platforms, JDBC makes it possible to write a single database application that can run on different platforms and interact with different DBMSs. Database 183 may reside on the server 139, PDA 117C, or the computer 100. A significant drawback of having all these components sitting between the browser 155 and the database 183 is that they have no direct relationship to the data being presented on the browser 155. However, as the next Figure illustrates, the relationship between the data presented on the UI and the data in the database is more direct.

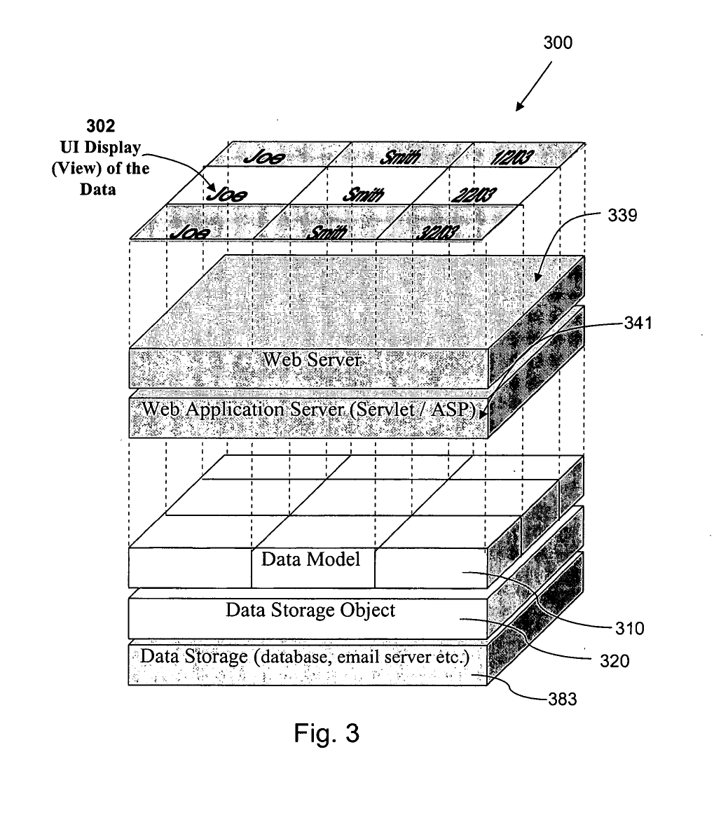

FIG. 2 is a diagram illustrating the relationship between data displayed in a UI 200 and data stored in a data storage, such as a database 205. As previously mentioned, the UI 200 is displayed on a display device such as a liquid crystal display or plasma display. A portion of the UI 200, referred to as the component view 202, displays multiple pieces of data retrieved from the database 205. In many cases, the pieces of data being presented on the UI 200 in the data view 202 have a direct one-to-one relationship with the data in the database 205. For example, if an application displays a list of names and dates on the UI 200, each piece of data may correspond to the rows and columns in the database 205. Thus, the data in the database columns 207A, 209A, and 211A matches the data in the data view columns 207B, 209B, and 211B. Similarly the database records 221A, 223A, and 225A match the data in data view 221B, 223B, and 225B. Although the close relationship between the data displayed on the UI 200 is apparent, there are no standard methods to describe it in today's software development paradigms. However, as FIGS. 3-5 illustrate, embodiments of the invention provide ways of building a channel among the UI 300, an inventive data model 310, and the database 383 for every piece of data in the table.

Although any of columns 207A, 209A, 211A or 213 may be designated as the database's primary key, the invention described herein does not require a primary key. Thus, each of the columns 207A, 209A, 211A and 213 may be ordinary columns of data.

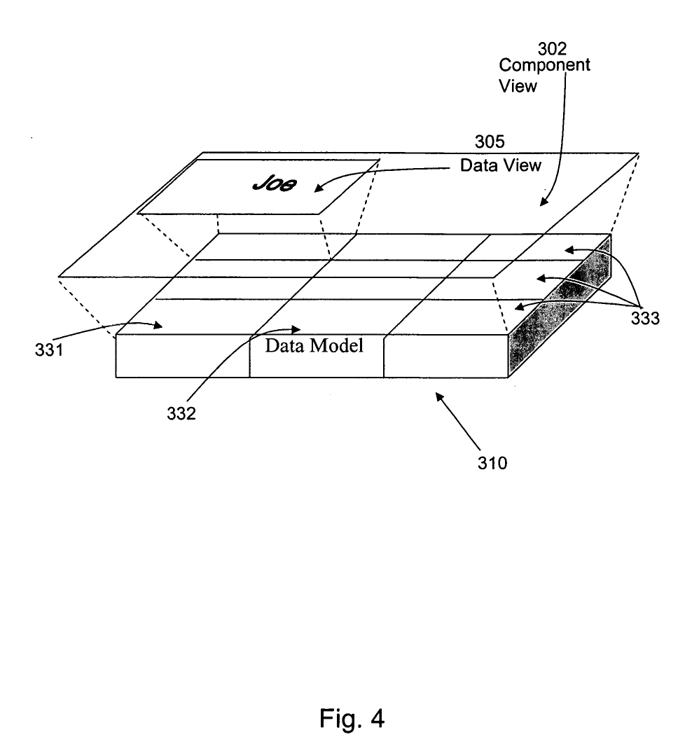

FIG. 3 is a diagram of inventive software components 310 and 320 that are independent of a data provider and which are used to create a direct channel between a user interface 302 and data stored in a data storage system 383, such as a database. FIG. 4 is a diagram illustrating a component view 302 and a data view 305 that are made possible when using a data model 310 such as that shown in FIG. 3.

As FIGS. 3 and 4 illustrate, an application framework manufactured according to the principles of the invention includes one or more components, which are the basic units used to construct a software application. A component is a logical entity comprised of three objects: a data model object 310, a view object (i.e., data view 305 or component view 302), and a data storage object 383. A data model object 310 is defined by specifying the fields (e.g., columns) of data that have to be retrieved from data storage. These fields can come from any data source for which a data storage object is defined.

The specified view takes the data from the data model object and presents it on a web page in a particular fashion. A view can draw an entire component or just one individual piece of data. In the component view 302, each piece of data in the data model 310 can have its own individual data view 305 that may be different from others. Thus, text data from a data source 383 in data cell 331 may appear at the same time that picture data from the same or different data source appears in data cell 332.

The data storage object 383 is responsible for getting data from the data source and placing them into the data model 310. It is also responsible for saving the data in the data model 310 to the data source. It has four basic operations related to data access. The four operations are CREATE, READ, UPDATE, and DELETE.

Referring again to FIG. 3, the data model 310 and data storage object 320 are software components of the invention that afford software developers flexibility in creating and designing component and data views for a UI 300. For example, the data model 310 provides a standardized layout of data, regardless of the configuration of the data storage 383 (database, email server, web server, etc.). The standardized layout of data, regardless of the schema of the underlying data source 383, permits UI 300 to be designed based on one or more assumed properties of the data model 310. Previously, this was not possible with conventional software components, such as those shown in FIG. 1C, because one could not assume any type of standardized layout at any component level, from the data storage 183 to the web server 139. Consequently, custom servlets 163 and custom server code 175 had to be coded by hand for each different type of database configuration encountered. In contrast, the present invention allows the UI 300 to access data from different data sources 383, even data sources that have a different configuration than the UI 300. Illustratively, this may be accomplished by providing a data storage object 320 which is configured to include ANSI SQL code. Since most SQL-based databases recognize ANSI SQL, the data storage object 320 can communicate with virtually any SQL-based database. In other embodiments, the data storage object 320 may be further customized to communicate with databases that use vendor-specific versions of SQL, such as databases that use Oracle, MY SQL, etc. Providing a single data object 320 eliminates having to hand-code many pages of UI code. Thus, the data storage object 320 can interact with virtually any data source 383 to access data, regardless of how that data is stored within the data source.

Once data is accessed, it is routed via the storage object 320 to the data model 310, which arranges the accessed data in a standardized matrix of m columns and n rows. For example, during a read operation, a data storage object designed for SQL databases may generate a SQL statement to retrieve a number of records from one or more tables and transfer the individual data in the resulting records to the data cells in the data model 310. Relationally, the data model 310 and data storage model 320 reside on the server-side, between a data storage 383 and a web application server (servlet/ASP) 341 associated with web server 339.

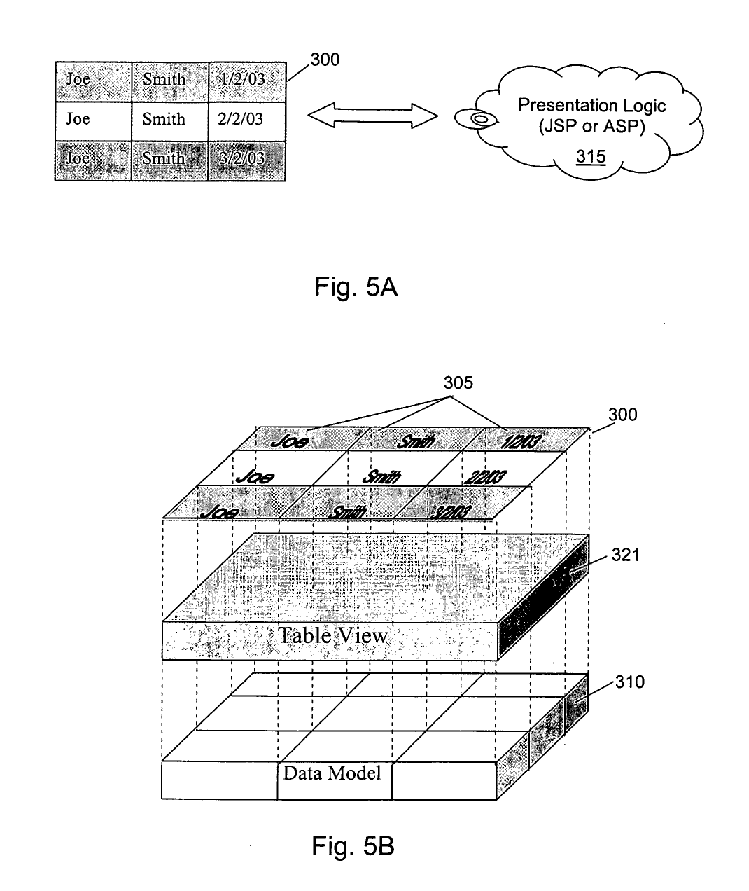

Referring to FIG. 4, the standardized matrix of m columns and n rows embodied by the data model 310 includes one or more data units 333 into which individual pieces of data accessed from the data source 383 are placed. Each of the data units 333 corresponds to a unique data view 305 that appears in the component view 302 of a UI 300. The formation of the standardized matrix may be accomplished by using one or more component definitions (further discussed below with respect to FIG. 5) and/or by referencing one or more keys in the data source 383, even though the data in the keys is not shown in the standardized matrix of the data model 310.

The data model 310 forms the heart of the software component. In addition to including a matrix of data objects, it may also have other attributes and behaviors such as a validator and a sorting order. Skilled artisans will appreciate that each data unit in the matrix is an independent unit, and that the value of the data can be any type of object, such as but not limited to, a text object, a picture object, a sound object, or other type of object. The source of the data can be a data storage 383, such as a database or email server, but it can also be another software component. Thus, each data object is capable of representing another software component.

The data storage 383 represents a database or other data container developed by a data provider. Because each of the pre-coded data storage objects 320 of the invention utilize a standard interface to create, read, update, and delete data, the data model 310 can operate independently of the data storage 383. Accordingly, a skilled artisan will appreciate that the specifics of how a pre-coded storage objects 320 communicates with the data storage 383 will vary based on the specific data provider.

FIG. 5A is a diagram illustrating a relationship between a user-interface 300 and a customized server-side presentation logic 315. When a web application is desired, the corresponding UI 300 is designed and implemented in HTML code. This HTML UI code is then integrated with some presentation logic using various server-side technologies such as servlet, Java Server Page (JSP), or Active Server Page (ASP). The presentation logic 315 retrieves data, formats it, and inserts it into the HTML UI elements to be displayed by the web browser. The presentation logic 315 also collects and processes data input into the web browser by a user.

FIG. 5B is a diagram illustrating how a table view 321 interacts with a data model object 310. In FIG. 5B, the custom-made presentation logic 315 shown in FIG. 5A is replaced by a standard data model object 310 and at least one pre-made view 321. The pre-made view 321 can be any UI element, such as a folder, a dropdown list, a menu, etc. A unique property of each view template 321 is that they can access and manipulate data right out of the box, without knowing the type or in-memory structure of the data. In one embodiment, for example, a text input box view may automatically display and updates the underlying data without a developer having to do any manual coding. The reason that the pre-made view 321 can do this is because it is able to precisely manipulate the standardized data model object 310, which is always an m by n matrix. An even more profound implication is that each pre-made view 321 is completely interchangeable. For example, the table view 321 can be easily replaced with a dropdown list view, which will display the same data as that displayed by the table view 321, but as a drop-down list instead of a table.

In FIG. 5B, the table view 321 presents a table of user information for display in the UI 300. Each data cell presented in the table maps to an element in the standard data model object 310. Thus, in one embodiment, the table view 321 is a component level template that processes each data element in the data model object 310 and presents it on the web browser in table form. The table view 321 may also assign the responsibility of drawing each individual data to each data view 305 that is assigned to the columns. For example, as shown, the first two columns of data, which are the first and last names of a user, are assigned a text view, which is a simple data view that displays strings of alphanumeric characters. Meanwhile, the third column is assigned a different view, a time view, which is used to display times and dates.

Illustratively, the following code snippet is part of a tableviewjsp.file that may be used to create a table view object 321.

```
Entry[ ] entries = component.getData( );
JspCanvas canvas = new JspCanvas(request, response, out);
...
for(int i = start; i < len; i++)
{
%>
<tr bgcolor=‘<%=(((i%2)==1 ? stripe :“#FFFFFF”))%>’ >
<%
  ...
  IData[ ] data = entries[i].getData( );
  for(int j=0; j<data.length; j++)
  {
    if(data[j] != null)
    {
      IView view = data[j].getView( );
      if(view != null)
        view.draw(canvas, data[j]);
    }
    else { %><td></td><%}
  }
...
}
%>
```

As a skilled artisan will appreciate, the code of the table view object 321 loops through the entire matrix of data objects provided by the data model object 310, and builds table rows (<tr>) and table cells (<td>) for the data. The table view object 321 need not draw each individual data cell, but may call upon the data's own view to draw each individual data cell.

As shown below, a different view 321 may be built. Thus, instead of displaying the data in a table as illustratively shown in FIG. 5B, it may be displayed as a list of sentences, such as, but not limited to:
Joe Smith's utility bill is due on 1/2/03.
Joe Smith's utility bill is due on 2/2/03.
Joe Smith's utility bill is due on 3/2/03.

The sentences above have the format of <first name> <last name>'s utility bill is due on <due date>. Consequently, the corresponding HTML code is:

<p>Joe Smith's utility bill is due on 1/2/03.</p>
<p>Joe Smith's utility bill is due on 2/2/03.</p>
<p>Joe Smith's utility bill is due on 3/2/03.</p>

To display the user information, the three columns of data in the component are coded to generate the above HTML code. For example,

Entry[ ] entries = component.getData( );
JspCanvas canvas = new JspCanvas(request, response, out);
...
for(int i = start; i < len; i++)
{
%>
<p>
<%
IData[ ] data = entries[i].getData( );
%>
<%=data[0].getView.draw(canvas, data[0]);%>&nbsp;
<%=data[1].getView.draw(canvas, data[1]);%>'s utility bill is due on
<%=data[2].getView.draw(canvas, data[2]);%>.
...
</p>
}
%>

In this manner, the actual drawing of each data cell is delegated to the appropriate view object. This enables data cells to be rendered independently. It also makes it possible to modify the view of the data cells by changing the configuration file, without changing the container component's view.

In some cases, however, a desired component view may not be able to delegate the rendering of data to the data views, such as the case where data fields are added or multiplied to produce a single result for display. Nevertheless, whenever possible, rendering of data cells should be delegated to maximize the reusability of the view object and to allow each data view to be configurable.

Once coded, the newly created component view JSP can be used simply by adding the new view definition to the component definition file, and changing the component's definition to use the new component view. Thus,

```
<view name=”MyComponentView”>
  <type>xcomponent.impl.view.html.JspComponentView</type>
    <jsp-file>/MyComponentView.jsp</jsp-file>
</view>
```

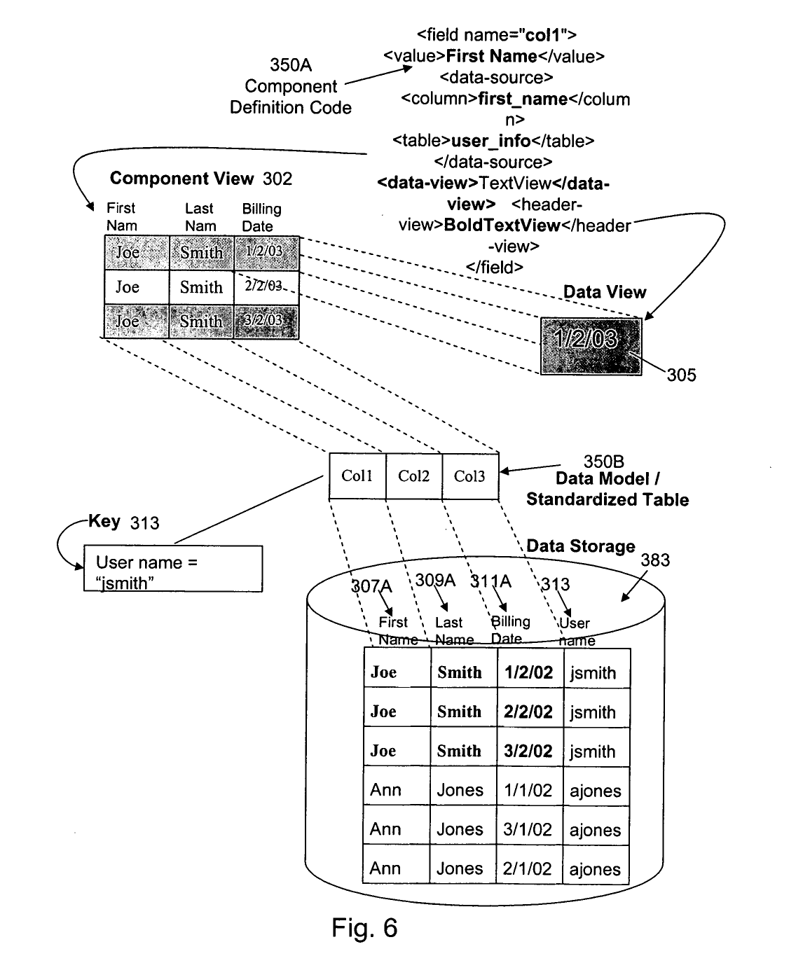

FIG. 6 is a diagram illustrating how the various views of FIG. 4 relate to data stored in a data storage 383. FIG. 6 also illustrates a component definition code 350B that maps data in a data storage 383 to various data views 305 within a component view 302. A component definition code 350A is included in the data model 310.

Illustratively, data storage 383 represents a list of clients organized by user name and billing date. A data storage object is configured to provide data access capability to the component according to the mapping between the fields of data model 350B and columns 307A, 309A, 311A, and 313 in the database 383. For example, to provide the read access to the data in data storage 383, the data storage object may generate a SQL statement such as “select first_name, last_name, billing_date from user_info where user_name=‘jsmith’”, according to the field mapping. The SQL statement is then issued to the database 383, and the resulting data is transferred to the data model 350 in matrix form. In this example, the key object 313 is used to restrict the resulting data set to only those records whose user_name column has the value of “jsmith”. The SQL database data storage object may use the key to generate the where clause of the SQL statement during data access. Although the above example has been used to describe a SQL database, one of skill in the art could modify such methods, in view of the description herein, to use different data storage objects, such as one designed for an email server, to support the four basic data access operations of create, read, update and delete.

A problem with conventional data storage is that different storage providers will name columns 307A, 309A, 311A, and 313 differently. Thus, a UI configured to locate data supplied by one data provider in the column named “First Name”, will not be able to access the same data supplied by a different data provider in a column “1^{st} Name”, unless, of course, the UI is hand-coded to reference the new column name “1^{st} Name.”

This problem is eliminated by the invention, which provides a component definition code 350A to map the data view 305 of a UI to the data stored in columns 307A, 309A, and 311A. Rather than trying to guess the column names provided by various data providers, the component definition code 350A simply references the UI to “Col 1”, “Col 2”, and “Col 3”. Illustratively, the invention's data storage object (not shown) interfaces with the data storage 383 to map column 307A to Col 1 of the standardized table 350A defined by the component definition code 350B. Similar mappings are made to associate column 309A with Col 2, and column 311A with Col 3. Thus, by referencing the respective data views 305 to the Col 1, Col 2, and Col 3 data units of the standardized table 350B, UI developers can swap data sources 383 without re-coding the views 302 and 305.

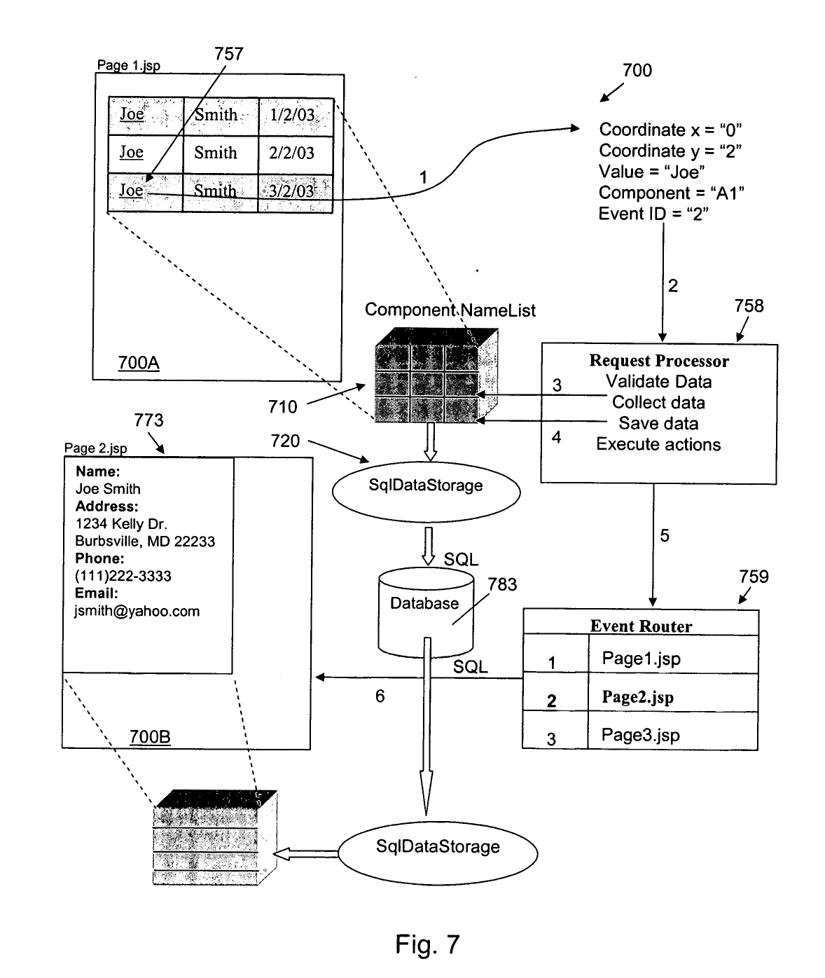

FIG. 7 is a diagram illustrating an application framework 700 designed to tie the software components, such as UI 700A and 700B, data model 710, and data storage object 720, together with other components to make a single application. The framework includes a URL handler 758 that will handle all HTTP requests from the components. This permits the software components to be independent of any particular application, and thus reusable by other projects. For example, when the components UI 700A and data model 710 are designed and implemented, little or nothing need be known about the application in which they will be used. Thus, for example, the invention permits a hyperlink 757 or button to be programmed into the component view of the UI 700A at a first time t₁. However, the destination (e.g., page2.jsp) of the link 757 need not be coded until a subsequent time t₂.

Thus, an illustrative method may include coding a UI 700 to reference destinations (e.g., page1.jsp, page2.jsp, page3.jsp, etc.) based on assumptions made about the standardized properties of the data model 710. In coding the UI 700A, one or more of the data views may be formatted to include a hyperlink 757. Thereafter, as indicated by arrow 1, additional coding regarding the destination and values of the hyperlink 757 may be added. Illustratively, the coding may include information such as, but not limited to:
Coordinate x=“0”
Coordinate y=“2”
Value=“Joe”
Component=“A1”
Event ID=“2”
   As indicated by arrow 2, the hyperlink 757 displayed by the UI 300A sends several pieces of information to the URL handler 758: the data's container component “A1”, its coordinates in the matrix data model (x=“0”, y=“2”), its value “Joe”, and an event ID “2” assigned at application design time. The value “2” of the Event ID references a primary key in an event router table 759. The event ID “2” selects a destination record “page2.jsp”. The event ID-destination mapping may be defined during the application design stage.

As indicated by arrow 3, when the URL handler 758 receives a request, it first collects the information sent from the components and updates the data model as necessary. This is accomplished using the data model 710 and underlying data storage object 720, which operate as previously described. The data storage object 720, which may include SQL statements, manipulates data in the database 783, and maps the accessed data to the standardized table of the data model 710.

Activities performed by the URL handler 758 include collecting data, validating data, saving data, and executing any actions that may be associated with one of more of the components. For example, a validator can be attached to each data object or component. When data is collected from the UI 700A, the validator is used to verify the user input.

Each component may also have one or more actions associated with it. These actions are executed after the URL request processor collects and updates the data model, but before the request are sent to the next destination. For example, the UI 700A shown in FIG. 7 illustratively displays a list of names; however, in another embodiment, the UI may display a login page, and a login action associated therewith may perform authentication using a username and password collected from the UI 700A.

Each data object in the data model may also have a transformer associated with it. Transformers are used to change the value of the data. For example, passwords stored in a database may be encrypted for security reasons. When a password is collected from the UI 700A, a transformer may be used to encrypt it before the password is compared to the database.

After performing any required validations, actions, and/or transformations, the URL handler 758, as indicated by arrow 5, uses the event ID “2” from the request to look up where the destination URL “page2.jsp” should be. During the construction of an application using the invention, a developer may define a routing table 759 to map the event IDs to their corresponding destination pages. As indicated by arrow 6, the URL handler 758 looks up the table 759 for the destination URL and then sends a request to the corresponding destination URL to display the next page 773 in the UI 700B.

As further explained below, with reference to Examples I, II, and III, the data model of the invention includes one or more components, and each component may have a unique definition. One example of a component definition is a <key> tag, which may be used to define one or more attributes of a database storage object constructed according to the principles of the invention. Although used to define a database storage object, the <key> tag is not the same as a database primary key. Instead a <key> tag functions as a qualifier for the data retrieved from a data storage.

For example, the code used to create a SQL Data Storage object may include a <key> tag that specifies particular criteria that the records retrieved from data storage must meet. The criteria may include column/value pairs in the where clause of the SQL statement, such as “where user-name=“joe_smith”. Additionally, the <key> tag may be defined in program code at run-time, because the criteria used to select records from data storage may not be known at the time the data storage object is designed and/or created.

As another example, a data storage object configured to interact with an Email data storage may include a <key> tag that specifies the name of a folder that contains one or more records of desired data. The particular value (e.g., folder name) of the <key> tag value, however, may be designated during application run-time, since it may not be known at design time.

A <key> tag may have different meanings in other types of data storage objects. Although the value of the <key> tag may be left to the choice of the data storage object designer(s), the <key> tag should serve as a data qualifier for the accessing of data records. Accordingly, the data storage developer should publish the meaning of the <key> tag and how to use it.

The following examples illustrate various components and component definitions that may be used in constructing an application framework according to the principles of the invention. These examples are illustrative in nature, and thus should not be read nor understood as including every type of component and/or component definition that may be used in the invention.

The following exemplary component definitions are provided as a reference to facilitate a better understanding of the types of <tags> that may be included in the machine-executable code used to create embodiments of the invention.

```
<component>
    This tag encloses the definition of a single component.
attributes
    name - name of the component definition.
<type>
    type of component. This is the fully qualified class name of the
component object.
<component-view>
    name of the component's view. The view must be defined in one of the
<view> tags
<data>
    this tag encloses the information about the data units of the
component.
    <field>
        this tag defines one column of the component data model.
    attributes
        name - name of the field
        <value>
            value of the field label
        <identity>
            designate the field as identity field, which is used to
        identify the row of data within the component.
        <data-view>
            view for each one of the data units in the field.
        <header-view>
            view for the header of the field
        <data-source>
            defines the data source of a single field of data.
            <column>
                name of the column. For a database column, it is
            the name of the column in the table.
            <table>
                for database data source only. name of the table
            the data field is from.
            <link-column>
                linking column in a join query on two or more
            tables.
            <link-table>
                linking table in a join query on tow or more
            tables.
        <transformer>
            data modifier for data value.
        <validator>
            data validation object to validate data value.
        <update>
            this is a flag to specify whether this field should be
        saved to the physical data provider during a create or update
        operation.
        Value= true/false
    <storage>
        defines the data storage of the component
        <type>
            fully qualified name of the storage class
    <key>
        specifies the key for data access. For a SQL data source, it is
    the parameters that are used to generate the where clause.
    <build-stub>
                specifies whether to insert stub data for each empty
            column so that user data could be collected. This tag must be
            set to true for an input field.
        <action>
            specifies the action to be done after user data is selected but before the next
        destination is invoked. For example, a login action can be specified after
        the user name and password are collected to do authentication.
            <type>
                type of action. Fully qualified name of the action class.
            <input-columns>
                specifies which columns in the data model are the input data to
            the action.
        <component-validator>
            Validation object for all data fields in the component.
        <sort-by>
            specifies the fields (index) that the data is sorted when it is displayed.
    <view>
        defines a view of a component or individual data unit
    attributes
        name - name of the view
        <type>
            type of the view. This is the fully qualified name of the view class.
        <jsp-file>
            for JSP views only. Specifies the JSP file used to display the view.
        <style>
            specifies the style for the view.
```

### EXAMPLE I

### Creation of Component “EmailMsgList”

The code snippets which follow may be processed by a web-browser, such as Microsoft Internet Explorer or Safari, a web-browser manufactured by Apple Computer. The web-browser operates on a computer, such as that illustratively shown and described in FIGS. 1A and 1B. When processed by a computer processor, the code snippets display an email message list in a user-interface, which is displayed for view on a display device, such as an Liquid Crystal Display (LCD), Light Emitting Diode Display (LEDD), Organic Light Emitting Diode Display (OLED), or Plasma Display.

Illustratively, the following exemplary code snippets are used to create only one component of an application framework constructed according to the principles of the invention. In this example, the application framework may provide the ability to host/manage an email server. Thus, a single component, appropriately named “EmailMsgList”, is defined to be of the type “xcomponent.impl.html.ServletComponent”. To display the list of email messages in either ascending or descending order, a component view “TableView” may be used to map the retrieved email message data into table format for display on the user interface. The code snippets used to create the component and its corresponding view(s), may be similar to the following:

```
<component name=“EmailMsgList”>
  <type>xcomponent.impl.html.ServletComponent</type>
  <component-view>TableView</component-view>
  <data>
    <field name=“col1”>
      <value>Sender</value>
      <data-source>
          <column>message_senders</column>
    </data-source>
      <data-view>TextView</data-view>
      <header-view>TextView</header-view>
      <header-event>TYPE_URL</header-event>
  </field>
    <field name=“col2”>
      <value><value/>
      <data-source>
          <column>message_mimetype</column>
      </data-source>
      <data-view>IconView</data-view>
  </field>
    <field name=“col3”>
      <value>Subject</value>
      <data-source>
          <column>message_subject</column>
    </data-source>
    <data-view>SubjectView</data-view>
    <header-view>TextView</header-view>
    <data-event>TYPE_URL</data-event>
    <header-event>TYPE_URL</header-event>
  </field>
    <field name=“col4”>
      <value>Date</value>
      <data-source>
          <column>message_rec_date</column>
    </data-source>
      <data-view>TimeView</data-view>
      <header-view>TextView</header-view>
      <header-event>TYPE_URL</header-event>
      <sort-order>desc</sort-order>
  </field>
    <field name=“col5”>
      <value>Size</value>
      <data-source>
          <column>message_size</column>
    </data-source>
      <data-view>SizeView</data-view>
      <header-view>TextView</header-view>
      <header-event>TYPE_URL</header-event>
      <sort-order>desc</sort-order>
  </field>
    <field name=“col6”>
      <value>Status</value>
      <data-source>
          <column>message_flags</column>
    </data-source>
  </field>
    <storage>
      <type>xcomponent.impl.email.EmailStorage</type>
  </storage>
    <key>
      <parent>INBOX</parent>
  </key>
    <control name=“select”>
      <type>xcomponent.impl.control.html.CheckBoxButton
          </type>
      <value />
      <header-view>CheckBoxButton</header-view>
      <data-view>CheckBoxButton</data-view>
    </control>
    <sort-by>3</sort-by>
  </data>
</component>
```

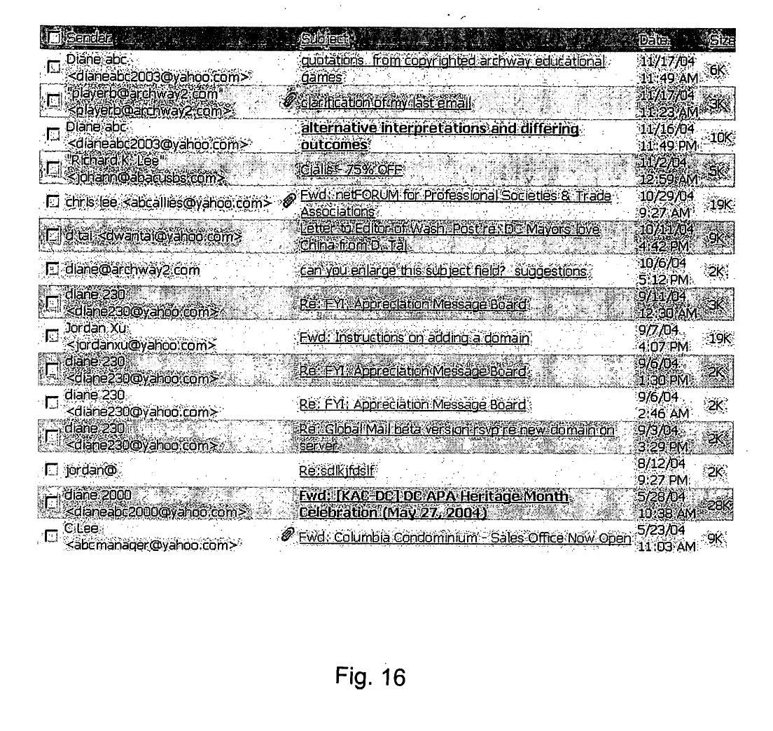

These exemplary code snippets, which are used to create a table having six columns, are explained, one by one, from top to bottom, as follows (FIG. 16). The first column of the table includes a header portion titled “Sender”. The data entries for this first column are specified to be retrieved from the “message_sender” field provided by a data storage object called EmailStorage, which is specified in the <storage> tag in the component definition above. Because the column title and the names of the message senders contain alphanumeric characters in this case, the respective header and data views are designated as “TextView”. Additionally, if it is desired to display each of the header title as a hyperlink, a header-event of “Type_URL” may be specified.

The table's second column includes an empty header as this column does not display any text in its header. The data entries for this first column are specified to be retrieved from the “message_mimetype” field provided by a data storage object called EmailStorage, which is specified in the <storage> tag in the component definition above. Because this message data contains the mimetype of the message, the data view is designated as “IconView” to display the mimetype graphically as icons.

The table's third column includes a header titled “Subject”. The data entries for this first column are specified to be retrieved from the “message_subject” field provided by a data storage object called EmailStorage, which is specified in the <storage> tag in the component definition above. The subject data view is specified to be “SubjectView”, and the header view is designated as “TextView” to display the header text, which is “Subject” in this case. Additionally, if it is desired to display each of the listed subjects as a hyperlink, a data-event of “Type_URL” may be specified. Similarly, a header-event of “Type_URL” may be specified to display the header title as a hyperlink.

The table's fourth column includes a header titled “Date”. The data entries for this first column are specified to be retrieved from the “message_rec_date” field provided by a data storage object called EmailStorage, which is specified in the <storage> tag in the component definition above. To display the time at which the message was received, the data view for this fourth column is designated as “TimeView”. As in other columns, the fourth column title header view is designated as “TextView”. A header-event of “Type_URL” is specified to display the header title as a hyperlink. Additionally, a descending sort order is applied to the data in the fourth column by including a sort order of “desc”. Alternatively, if an ascending sort order were desired, the sort order would be specified as “asc”.

The table's fifth column includes a header titled “Size”. The data entries for this first column are specified to be retrieved from the “message_size” field provided by a data storage object called EmailStorage, which is specified in the <storage> tag in the component definition above. The size of the message is calculated by designating the data view as “SizeView”. The header view is again designated as “TextView”, and the header-event of “Type_URL” is specified to display the header title as a hyperlink. Additionally, a descending sort order is applied to the data in the fifth column by including a sort order of “desc”.

The table's sixth column includes a header titled “Status”. The data entries for this first column are specified to be retrieved from the “message_flags” field provided by a data storage object called EmailStorage, which is specified in the <storage> tag in the component definition above.

Additionally, a storage container of “xcomponent.impl.email.EmailStorage” may be specified, from which the email data is retrieved and mapped. A key may be defined as a parent “Inbox” to specify that the messages displayed by this component are from the user's Inbox folder. If it is desired to include a checkbox next to each table row so that one or more email messages can be selected for various operations such as deletion, a control name “select” may be specified of the type “xcomponent.impl.control.html.CheckBoxButton”. Specifying the data view for the control column as “CheckboxButton” delegates and enables the automatic rendering of a checkbox in the appropriate data cells.

Another example, illustrating components used to create an application having a login page, a sign-up page, and a member list page is set forth in Example III, below. However, the components of the invention are not to be construed as being limited to this exemplary use, and may be used to create virtually any type of application desired.

### EXAMPLE II

A web-based application framework constructed in accordance with the principles of the invention may also be used to create a web-based membership application with a login page, a sign-up page, and a member list page. The web-based membership application may include a database that contains some information about a user's account, such as their login ID, password, name, and phone number. The login page allows users to type in their login ID and password and to authenticate them against the information in the database. The sign-up page lets new users enter their information to create a new account. The member list page is a simple list of all users and their account information. The exemplary web-based application described below provides a simple example of how to build a component-based application according to the principles of the invention. Skilled artisans will appreciate that an application framework constructed in accordance with the principles of the invention may include additional features not described in this example.

Identify the Data Source

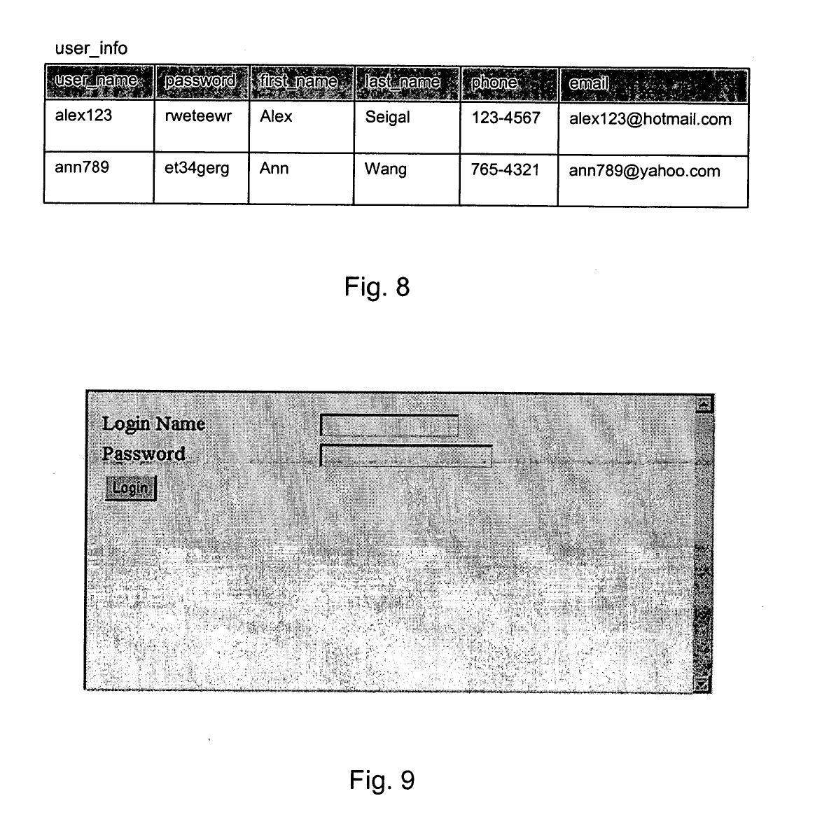

First, a members table should be identified in the database which will hold the information of the members. The table does not have to be a brand new one. It can be an already existing database. FIG. 8 shows one embodiment of a suitable table.

Setting up a J2EE Web Application

Next, a J2EE web application should be established. This means creating a directory structure such as, but not limited to:

```
[member_app]
    [WEB-INF]
        components.xml
        events.xml
        config.xml
        [lib]
            jar-files
            [classes]
        [jsp]
```

The config.xml file in the WEB-INF directory is used to specify various application information. The following code snippet illustrates how the config.xml file will look like in the example application.

```
<?xml version=“1.0” encoding=“UTF-8” ?>
  <config>
  <catalog-file> components.xml</catalog-file>
  <event-router> events.xml</event-router>
  <db-connection-url>
jdbc:mysql://localhost/sample_app?user=app&amp;autoReconnect=true
    </db-connection-url>
  <db-driver>org.gjt.mm.mysql.Driver</db-driver>
  <db-max-connections>500</db-max-connections>
  </config>
```

The components.xml file is where all of the components used in the application are defined. The Events.xml file is where the page flow of the web application is defined.

Login Page

With the data source identified, the first page, the login page, can be created. Two pieces of data are used in a login screen: the user name and the password.

To define the login component, the components.xml file may be created inside the WEB-INF directory. In the component definition, two fields of data, the user name and the password, must be specified. The following code snippet illustrates how the login component might be defined.

```
<component name=“Login”>
    <type>xcomponent.impl.html.ServletComponent</type>
    <component-view>LoginView</component-view>
    <data>
        <field name=“username”>
            <value>Login Name</value>
            <data-source>
                <column>user_name</column>
                <table>user_info</table>
            </data-source>
            <data-view>UserNameInput</data-view>
            <header-view>TextView</header-view>
        </field>
        <field name=“password”>
            <value>Password</value>
            <data-source>
                <column>password</column>
                <table>user_info</table>
            </data-source>
            <data-view>PasswordInput</data-view>
            <header-view>TextView</header-view>
        </field>
        <storage>
            <type>xcomponent.impl.sql.SqlDataStorage</type>
        </storage>
        <build-stub>true</build-stub>
    </data>
    <action>
        <type>xcomponent.impl.sql.LoginAction</type>
        <input-columns>0,1</input-columns>
    </action>
</component>
```

Looking at this piece of XML code in more detail, it is seen that every component is defined inside the <component> tag, and that the name attribute specifies the unique name of the component definition. The significance of each <tag> is described below.
<type>xcomponent.impl.html.ServletComponent</type>
The tag <type> tells the web-based application framework what the class type of component is. All components must implement the Icomponent interface. For a J2EE web application, ServletComponent should be used.
   <component-view>LoginView</component-view>
The <component-view>tag is used to specify the component's view. This view (LoginView) must be defined in with a <view> tag, which is not shown here.
   <data> . . . </data>

The <data> tag encloses all data related information, including the data source.

```
<field name=“username”>
  <value>Login Name</value>
  ...
  <data-view>UserNameInput</data-view>
  <header-view>TextView</header-view>
</field>
```

The <field> section is where one individual data field in the component is defined. In this case, field called username is defined. The text “Login Name” inside the <value> tag will be shown as the label of the field.

<data-source>
<column>user_name</column>
<table>user_info</table>
</data-source>

The <data-source> tag provides information about the source of the data field. In this case, it specifies the column and table in the database where the data is stored.
   <data-view>UserNameInput</data-view>
The <data-view> tag is used to indicate the view of the data field. In this case the view used to show the user name field is a text input box view called UserNameInput.
   <header-view>TextView</header-view>

The <header-view> tag specifies the view used to display the header or label of the field, which is “Login Name” in this case.

```
<field name=“password”>
  <value>Password</value>
  <data-source>
  <column>user_password</column>
  <table>user_info</table>
  </data-source>
  <data-view>PasswordInput</data-view>
  <header-view>TextView</header-view>
</field>
```

This section of code provides the data field definition for the password.

<storage>
<type>xcomponent.impl.sql.SqlDataStorage</type>
</storage>

The <storage> tag denotes the data storage used to access the component's data. In this case, the SqlDataStorage class is used to query as well as manipulate the data from the database.
   <build-stub>true</build-stub>

The <build-stub> tag tells the web-based application framework whether to build a stub data object for the fields so that it can hold input data when the user submits it.

<action>
<type>xcomponent.impl.sql.LoginAction</type>
<input-columns>0,1</input-columns>
</action>

The <action> tag introduces a new element called Action. Actions, which implement the IAction interface, perform certain tasks right after the user input have been collected from the UI. In this case, the LoginAction is used to authenticate the input typed in by the user against the use name and password fields from the database. The <input-columns> tag specifies which fields from the UI are needed by the action. They are the first two fields, field 0 and field 1 from the field definition section, which correspond to the user name and password field.

FIG. 9 illustrates the how the login web page defined above may look when displayed on a display device.

View

In order to display a component, the view(s) specified in the component definition above must be defined as well. Illustratively, the view definition of Login View, the view for the login component may be:

<view name=“LoginView”>
<type>
xcomponent.impl.view.html.JspComponentView
</type>
<jsp-file>/jsp/LoginView.jsp</jsp-file>
</view>

In the above code snippet, the LoginView.jsp file is used to display the login component. This JSP knows nothing about where the data comes from or in what system it is used. It simply displays the data in the component using the data view specified for each of the two fields.

```
<view name=“TextView”>
  <type>xcomponent.impl.view.html.JspView</type>
  <jsp-file>/jsp/TextView.jsp</jsp-file>
</view>
```

Similarly, the TextView is used to display the labels of the fields, namely “Login Name” and “Password”.

```
<view name=“UserNameInput”>
  <type>xcomponent.impl.view.html.JspView</type>
  <jsp-file>/jsp/TextInput.jsp</jsp-file>
</view>
```

The UserNameInput displays an input text box for the user name field.

Container Page

Once a login component has been defined, a container JSP file should be created to host the component. The following code snippet illustrates how such a container JSP file might be created.

login.jsp

```
<%@page contentType=“text/html”%>
<html>
<body>
<%
  UserSession.endSession(request, session);
  ServletComponent comp =
      (ServletComponent)session.getAttribute(“login”);
  JspCanvas canvas = new JspCanvas(request, response, out);
  if(comp == null)
  {
    comp = (ServletComponent)
      ComponentFactory.getInstance( ).newInstance(“Login”);
    Connection conn = DbConnectionManager.getConnection( );
    SqlDataStorage sql = (SqlDataStorage)comp.getDataStorage( );
    sql.setConnection(conn);
    comp.setId(“login”);
    comp.save(session);
  }
  request.setAttribute(“submit”, “Login”);
  comp.getView( ).draw(canvas, comp);
%>
</body>
</html>
```

This is all that is needed to create a login page that authenticates against real user data from the specified database.

Member List Page

To build the member list page, the developer must decide which fields from the database to show. In this example, five fields out of the table will be displayed. Which five are selected does not really matter. However, the password field, which contains private information that should never be shown, should not be selected for display. Furthermore, as shown in FIG. 10, the first field can be formatted as a hyperlink to the information sign-up page. FIG. 10 illustrates how a member list might look when displayed on a user interface. The following code snippet may be used to create the member list shown in FIG. 10.

```
<component name=“MemberList”>
    <type>xcomponent.impl.html.ServletComponent</type>
    <component-view>TableView</component-view>
    <data>
        <field name=“col1”>
            <value>User Name</value>
            <data-source>
                <column>user_name</column>
                <table>user_info</table>
            </data-source>
            <data-view>TextView</data-view>
            <header-view>TextView</header-view>
            <data-event>TYPE_URL</data-event>
        </field>
        <field name=“col2”>
            <value>First Name</value>
            <data-source>
                <column>first_name</column>
                <table> user_info </table>
            </data-source>
            <data-view>TextView</data-view>
            <header-view>TextView</header-view>
        </field>
        <field name=“col3”>
            <value>Last Name</value>
            <data-source>
                <column>last_name</column>
                <table>user_info</table>
            </data-source>
            <data-view>TextView</data-view>
            <header-view>TextView</header-view>
        </field>
        <field name=“col4”>
            <value>Phone</value>
            <data-source>
                <column>phone</column>
                <table>user_info</table>
            </data-source>
            <data-view>TextView</data-view>
            <header-view>TextView</header-view>
        </field>
        <field name=“col5”>
            <value>E-mail</value>
            <data-source>
                <column>email</column>
                <table>user_info</table>
            </data-source>
            <data-view>TextView</data-view>
            <header-view>TextView</header-view>
        </field>
        <storage>
            <type>xcomponent.impl.sql.SqlDataStorage</type>
        </storage>
        <sort-by>2</sort-by>
    </data>
</component>
```

The MemberList component definition is very similar to that of the login component, but there are several differences. First, the MemberList uses a component view called Table View. It is defined as follows.

<view name=“TableView”>
<type>xcomponent.impl.view.html.JspComponentView</type>
<jsp-file>/jsp/TableView.jsp</jsp-file>
</view>

This view displays data in a table form.

The <sort-by> tag simply tells the web-based application framework to sort the table fields by column 3 (third column), which is the last name field. The last major difference is the addition of the <data-event> tag in the definition.

<data-event>TYPE_URL</data-event>

This tag tells the web-based application framework that the field should generate an event when clicked, and the event is a URL to another page. Since a component, which may be reusable in the future, is being designed, the destination of the event should not be determined now. The only concern is to make the field data a hyperlink.

Once the MemberList component is defined, a JSP container is created, and the MemberList component is dropped therein for display. The following code snippet illustrates this process.

Member_list.jsp

```
<%@page contentType=“text/html”%>
<html>
<body>
<%
  UserSession userSession =
      UserSession.getSession(request, session, false);
ServletComponent comp = (ServletComponent)
            userSession.getInfo(“memberList”);
JspCanvas canvas = new JspCanvas(request, response, out);
if(comp == null)
{
    comp = (ServletComponent)
        ComponentFactory.getInstance( ).newInstance(“MemberList”);
    Connection conn = DbConnectionManager.getConnection( );
    SqlDataStorage sql = (SqlDataStorage)comp.getDataStorage( );
    sql.setConnection(conn);
    comp.setId(“memberList”);
  }
  comp.getView( ).draw(canvas, comp);
%>
</body>
</html>
```

Sign-Up Page

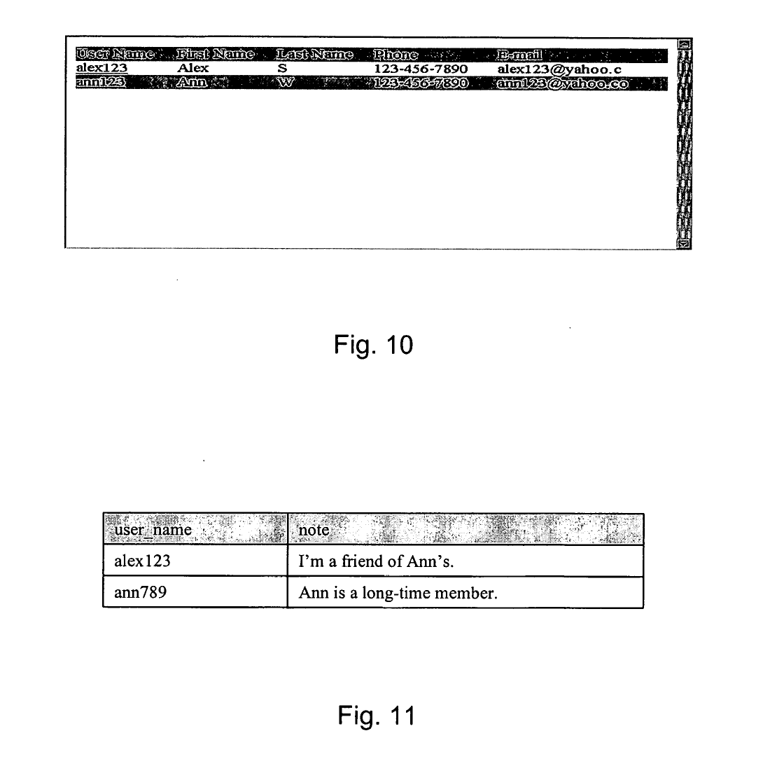

The third and last page to build is the member information sign-up page. This page is invoked when the user clicks on the hyperlink in the first field of the member list. Sometimes it might be necessary to access data from multiple tables in a database. Illustratively, in addition to the four fields from the user_info table, a developer can add one field related to the user (the note field) from another table (the notes table). FIG. 11 illustrates one embodiment of a notes table. Notice that the primary key of the notes table is the user_name column in the user_info table. When the user enters some text in the “Note” field, it will be saved to the notes table.

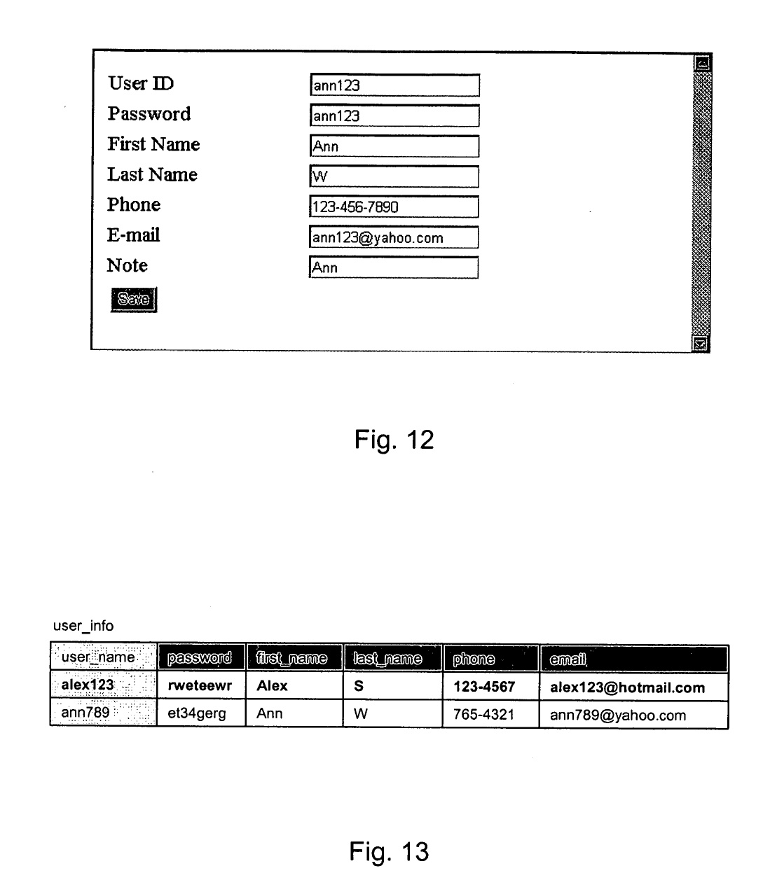

FIG. 12 illustrates how an update component might look when viewed in a user interface. An illustrative component definition for the update component may include the following code snippet.

```
<component name=“UpdateInfo”>
    <type>xcomponent.impl.html.ServletComponent</type>
    <component-view>TextInputView</component-view>
    <data>
        <field name=“col1”>
            <value>First Name</value>
            <data-source>
                <column>first_name</column>
                <table>user_info</table>
            </data-source>
            <data-view>TextView</data-view>
            <header-view>TextView</header-view>
            <update>true</update>
        </field>
        <field name=“col2”>
            <value>Last Name</value>
            <data-source>
                <column>last_name </column>
                <table>user_info</table>
            </data-source>
            <data-view>TextView</data-view>
            <header-view>TextView</header-view>
            <update>true</update>
        </field>
        <field name=“col3”>
            <value>Phone</value>
            <data-source>
                <column>phone</column>
                <table>user_info</table>
            </data-source>
            <data-view>TextInput</data-view>
            <header-view>TextView</header-view>
            <update>true</update>
        </field>
        <field name=“col4”>
            <value>E-mail</value>
            <data-source>
                <column>email</column>
                <table>user_info</table>
            </data-source>
            <data-view>TextInput</data-view>
            <header-view>TextView</header-view>
            <update>true</update>
        </field>
        <field name=“col5”>
            <value>Note</value>
            <data-source>
                <column>note</column>
                <table>notes</table>
                <link-column>user_name</link-column>
                <link-table> user_info</link-table>
            </data-source>
            <data-view>TextInput</data-view>
            <header-view>TextView</header-view>
            <update>true</update>
        </field>
        <storage>
            <type>xcomponent.impl.sql.SqlDataStorage</type>
        </storage>
    </data>
</component>
```

In the definition of the “Note” field, in addition to the usual <column> and <table> tags, there are two new tags, namely the <link-column> and <link-table> tags. These tags assist in retrieving and updating the note field in the notes table. The note for user alex 123 is “I'm a friend of Ann's”. The linking column between the two tables is user_name. It is specified by the <link-column> tag. The <link-table> tag specifies the table in which the linking column resides. FIG. 13 shows a user-info table.

Once the update component is defined, it should be placed within a JSP container. One such illustrative JSP container is:

update.jsp

```
<%@page contentType=“text/html”%>
<html>
<body>
<%
  UserSession userSession =
    UserSession.getSession(request, session, false);
  ServletComponent comp = (ServletComponent) userSession.
  getInfo(“update”);
  JspCanvas canvas = new JspCanvas(request, response, out);
  if(comp == null)
  {
    comp = (ServletComponent)
          ComponentFactory.getInstance( ).newInstance(“UpdateInfo”);
    Connection conn = DbConnectionManager.getConnection( );
    SqlDataStorage sql = (SqlDataStorage)comp.getDataStorage( );
    sql.setConnection(conn);
    comp.setId(“update”);
  }
  comp.toBeSaved(true);
  request.setAttribute(“submit”, “Save”);
  comp.getView( ).draw(canvas, comp);
%>
</body>
</html>
```

Data Field Validation

When the user enters data, the application needs to validate the input to make sure it is valid. The invention's web-based application framework provides an easy way to validate user input. To add some validation capability to the example web application, the developer must identify which input fields have to be validated. In this example, the first name and last name fields will be limited to have one to fifteen characters. This is accomplished by adding the following validator tags in the data field definitions, which are shown in italic below.

```
<field name=“col1”>
    <value>First Name</value>
    <data-source>
        <column>first_name</column>
        <table>user_info</table>
    </data-source>
    <data-view>TextView</data-view>
    <header-view>TextView</header-view>
    <validator>
        <type>xcomponent.impl.view.TextValidator</type>
        <min-len>1</min-len>
        <max-len>15</max-len>
    </validator>
    <update>true</update>
</field>
<field name=“col2”>
    <value>Last Name</value>
    <data-source>
        <column>last_name </column>
        <table>user_info</table>
    </data-source>
    <data-view>TextView</data-view>
    <header-view>TextView</header-view>
    <validator>
        <type>xcomponent.impl.view.TextValidator</type>
        <min-len>1</min-len>
        <max-len>15</max-len>
    </validator>
    <update>true</update>
</field>
```

Component Validation

At times, it may be necessary to validate two or more fields at a time. For example, a rule could be set that the user must enter either an email or a phone number. To do this, the developer should write a Validator class (all validators must implement the IComponentValidator interface). In this example, a class is written that derives from the XComponentValidator class. This abstract class already provides the parameters parsed from the XML. In this example, it is desired to write a component validator that will take a number of input fields from the component, examine their value, and insure that at least one of them is not empty. However, in order not to obscure the invention, the details of the logic inside the class are not shown. However, such details will be readily apparent to the skilled artisan. The following snippet shows the part of the method validates which all Validators must implement.

```
public class MyCompValidator extends XComponentValidator
{
  public void validate(IComponent component) throws DataException
  {
    ...
  }
}
```

Next, the component validator should be added to the component definition. The <component-validation> tag, shown in italic below, is added after the field definitions.

```
<field name=“col5”>
    <value>Note</value>
    <data-source>
        <column>note</column>
        <table>notes</table>
        <link-column>user_name</link-column>
        <link-table> user_info</link-table>
    </data-source>
    <data-view>TextInput</data-view>
    <header-view>TextView</header-view>
    <update>true</update>
</field>
<component-validator>
    <type>MyCompValidator</type>
</component-validator>
<storage>
    <type>xcomponent.impl.sql.SqlDataStorage</type>
</storage>
```

Data Transformation

Sometimes the input from the user is not exactly what is desired. Accordingly, the data would need to be altered before performing any actions using the data. For example, many systems encrypt the password before it is saved to the database instead of storing clear text. It is done for security reasons, so that the stored passwords cannot be discovered. Thus, to authenticate a user, the login module must retrieve the encrypted password from the database, encrypt the user's input password, and then compare the two. That means the input data must be transformed once it reaches the server. To do this, a transformer for the data field should be specified. The following code snippet includes the definition for the password field in the login component. The <transformer> tag, which is shown in italic below, is added to the password field definition.

```
<field name=“password”>
    <value>Password</value>
    <data-source>
        <column>password</column>
        <table>user_info</table>
    </data-source>
    <data-view>PasswordInput</data-view>
    <header-view>TextView</header-view>
    <transformer>
      <type>xcomponent.impl.PasswordEncryptor</type>
    </transformer>
</field>
```

Transformers replace the original data with the transformed value. In this case, the password that the user types in is replaced with the encrypted version. Then the login action will use this transformed value to authenticate against the password in the database, which is also encrypted the same way. It will be appreciated that a developer can write his own transformer and specify it in the field definition. A transformer must implement the ITransformer interface, although a developer is better off deriving from the XTransformer class which performs loading information from the definition file automatically.

Designing Page Flow with Event ID

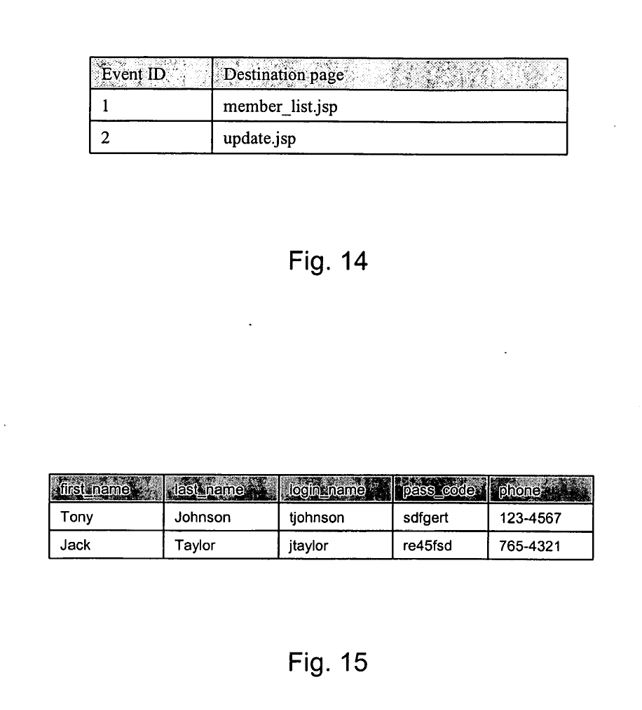

Once all pages have been created, they are put in a page flow. In the exemplary application, the login page is the first page, the member list page is the second page, and the update page is the last page. To do this, an event ID must be assigned to a destination page. The event ID's are paired with corresponding destination pages in a table similar to that shown in FIG. 14.

To define the page flow, another XML configuration file called events.xml is created in the WEB-INF directory. The name of this file was previously specified in the config.xml file.

event.xml

```
<?xml version=“1.0” encoding=“UTF-8” ?>
<event-router>
<event>
    <id>1</id>
    <destination>/jsp/member_list.jsp</destination>
</event>
  <event>
    <id>2</id>
    <destination>/jsp/update.jsp</destination>
</event>
</event-router>
```

Next, the event ID's for the JSP pages that we created earlier should be used. To do this, simply add the line of code that is in italic below in the container JSP file.

login.jsp

```
<%@page contentType=“text/html”%>
<html>
<body>
<%
  UserSession.endSession(request, session);
  ServletComponent comp =
      (ServletComponent)session.getAttribute(“login”);
  JspCanvas canvas = new JspCanvas(request, response, out);
  if(comp == null)
  {
    comp = (ServletComponent)
      ComponentFactory.getInstance( ).newInstance(“Login”);
    Connection conn = DbConnectionManager.getConnection( );
    SqlDataStorage sql = (SqlDataStorage)comp.getDataStorage( );
    sql.setConnection(conn);
    comp.setId(“login”);
  }
  JspCommon.setEventID(request, 1);
  setAttribute(“submit”, “Login”);
  comp.getView( ).draw(canvas, comp);
%>
</body>
</html>
```

When the user clicks the login button, the application framework will invoke the LoginAction and then forward the request to the destination page assigned to event ID 1, which is member_list.jsp. Now to use event ID 2 in member_list.jsp, a developer can use the same simple call shown in italic below.

member_list.jsp

```
<%@page contentType=“text/html”%>
<html>
<body>
<%
  UserSession userSession =
      UserSession.getSession(request, session, false);
  ServletComponent comp = (ServletComponent)
      userSession.getInfo(“memberList”);
  JspCanvas canvas = new JspCanvas(request, response, out);
  if(comp == null)
  {
    comp = (ServletComponent)
      ComponentFactory.getInstance( ).newInstance(“MemberList”);
    Connection conn = DbConnectionManager.getConnection( );
    SqlDataStorage sql = (SqlDataStorage)comp.getDataStorage( );
    sql.setConnection(conn);
    comp.setId(“memberList”);
  }
  JspCommon.setEventID(request, 2);
  comp.getView( ).draw(canvas, comp);
%>
</body>
</html>
```

Next, use event ID 1 to have the update page go back to the member list page after the user saves the information. Again, the same call to set the event ID is shown in italic below.

update.jsp

```
<%@page contentType=“text/html”%>
<html>
<body>
<%
  UserSession userSession =
      UserSession.getSession(request, session, false);
  ServletComponent comp = (ServletComponent)
      userSession.getInfo(“update”);
  JspCanvas canvas = new JspCanvas(request, response, out);
  if(comp == null)
  {
    comp = (ServletComponent)
      ComponentFactory.getInstance( ).newInstance(“UpdateInfo”);
    Connection conn = DbConnectionManager.getConnection( );
    SqlDataStorage sql = (SqlDataStorage)comp.getDataStorage( );
    sql.setConnection(conn);
    comp.setId(“update”);
  }
  request.setAttribute(“submit”, “Save”);
  JspCommon.setEventID(request, 1);
  comp.getView( ).draw(canvas, comp);
%>
</body>
</html>
```

Data Source Customization

At last, a complete web application with a login page, a member list and an update page has been created. One of the unique features of the web-based application framework of the invention is that the framework completely separates the UI display of the data from the data source. Thus, to change the data source, the developer need only modify the appropriate component definition. One example involves changing the data source of the login page in our web application. Instead of getting data from the user_name and password column of the user_info table, the application will now authenticate users against a different table called client_info, illustratively shown in FIG. 15.

To change data sources, a developer need only modify the italic parts of the login component's definition, which appear below.

```
<field name=“username”>
    <value>Login Name</value>
        <data-source>
            <column>login_name</column>
            <table>client_info</table>
        </data-source>
        <data-view>UserNameInput</data-view>
        <header-view>TextView</header-view>
    </field>
    <field name=“password”>
        <value>Password</value>
        <data-source>
            <column>pass_code</column>
            <table>client_info</table>
        </data-source>
    <data-view>PasswordInput</data-view>
    <header-view>TextView</header-view>
</field>
```

Customizing Actions

If a developer wishes to change the login page to authenticate against an LDAP server instead, the developer should write a new LdapLoginAction class for LDAP. The new action class must derive from the XLoginAction class. After a new LoginAction is created, the developer need only modify the login component definition (as indicated by the italic section below) to use it instead of the old LoginAction.

<action>
<type>LdapLoginAction</type>
<input-columns>0,1</input-columns>
</action>

Customizing to Different Data Storage Types

In all of the component definitions in the example web application, the data storage defaults to SqlDataStorage, which is shown in italic below. Thus,

<storage>
<type>xcomponent.impl.sql.SqlDataStorage</type>
</storage>

However, the data can come from virtually any type of data provider, such as an EJB server, a SOAP server, or an E-mail server. For each type of data provider, a data storage class must be written to enable a web-based application framework to access the data. All data storage classes must implement the IDataStorage interface, although it is easier to derive from XDataStorage which already provides some useful behaviors such as loading from the definition. The flexibility is very useful when it comes to customizing an application to adapt to different data providers. For instance, a CRM (Customer Relations Management) application written using the inventive web-based application framework can be easily adapted to different data systems without messy code changes.

Customizing Views

As discussed above, the views of each component and individual data units are configurable as well. The unique characteristic about these views is that they do not have any idea about the source of the data. For example, the application can be re-configured to retrieve and display any number of data fields without changing any code. This is very important when it is desired to easily re-customize an application after it has been upgraded to a new version, a very common problem for today's software products.

A final example, illustrating components used to create an application used to host/access an email server is set forth in Example III, below. However, the components of the invention are not to be construed as being limited to this exemplary use, and may be used to host/access virtually any type of server desired.

### EXAMPLE III

In one embodiment, a web-based application framework constructed according to the principles of the invention may provide access to an email server. Code segments directed to various components of such a web-based application framework include, but are not limited to the following.
<?xml version=“1.0” encoding=“UTF-8”?>
<!--
   Document: components.xml
   Created on: Feb. 30, 2050, 3:32 PM
   Description: Web-based framework using data model and data storage objects to provide access to data on email server.
      Purpose of the document follows.
-->
<components
xmlns=“http://www.alliesglobal.com”
xmlns:xsi=“http://www.w3.org/2001/XMLSchema-instance”
xsi:schemaLocation=“http://www.alliesglobal.com components.xsd”>
   <component name=“EmailLogin”>
      <type>xcomponent.impl.html.ServletComponent</type>
      <component-view>LoginView</component-view>
      <data>
      <field name=“username”>
         <value>Email Address</value>
         <data-view>TextInput</data-view>
         <header-view>LoginTextView</header-view>
      </field>
      <field name=“password”>
         <value>Password</value>
         <data-view>PasswordInput</data-view>
         <header-view>LoginTextView</header-view>
      </field>
      <storage>
         <type>xcomponent.impl.email.EmailStorage</type>
         <host>localhost</host>
      </storage>
      <build-stub>true</build-stub>
   </data>
   <action>
      <type>globalmail.LoginAction</type>
      <input-columns>0,1</input-columns>
   </action>
</component>
<component name=“FolderList”>
   <type>xcomponent.impl.html.ServletComponent</type>
   <component-view>ListView</component-view>
   <data>
      <field name=“col1”>
         <value>Folders</value>
         <data-source>
         <column>folder_list</column>
         </data-source>
         <data-view>TextView</data-view>
         <data-event>TYPE_URL</data-event>
      </field>
      <storage>
         <type>xcomponent.impl.email.EmailStorage</type>
      </storage>
   </data>
</component>
<component name=“DestFolderList”>
   <type>xcomponent.impl.html.ServletComponent</type>
   <component-view>ListBoxView</component-view>
   <data>
      <field name=“col1”>
         <value>Folders</value>
         <data-source>
         <column>folder_list</column>
         </data-source>
      </field>
      <control name=“select”>
         <value></value>
   <type>xcomponent.impl.control.html.GenericChoiceControl</type>
      </control>
   </data>
</component>
<component name=“EmailMsgList”>
   <type>xcomponent.impl.html.ServletComponent</type>
   <component-view>TableView</component-view>
   <data>
      <field name=“col1”>
         <value>Sender</value>
         <data-source>
         <column>message_senders</column>
         </data-source>
         <data-view>TextView</data-view>
         <header-view>TextView</header-view>
         <header-event>TYPE_URL</header-event>
      </field>
      <field name=“col2”>
         <value> </value>
         <data-source>
         <column>message_mimetype</column>
         </data-source>
         <data-view>IconView</data-view>
         <header-view>TextView</header-view>
      </field>
      <field name=“col3”>
         <value>Subject</value>
         <data-source>
         <column>message_subject</column>
         </data-source>
         <data-view>SubjectView</data-view>
         <header-view>TextView</header-view>
         <data-event>TYPE_URL</data-event>
         <header-event>TYPE_URL</header-event>
      </field>
      <field name=“col4”>
         <value>Date</value>
         <data-source>
         <column>message_rec_date</column>
         </data-source>
         <data-view>TimeView</data-view>
         <header-view>TextView</header-view>
         <header-event>TYPE_URL</header-event>
         <sort-order>desc</sort-order>
      </field>
      <field name=“col5”>
         <value>Size</value>
         <data-source>
         <column>message_size</column>
         </data-source>
         <data-view>SizeView</data-view>
         <header-view>TextView</header-view>
         <header-event>TYPE_URL</header-event>
         <sort-order>desc</sort-order>
      </field>
      <field name=“col6”>
         <value>Status</value>
         <data-source>
         <columnn>message_flags</column>
         </data-source>
      </field>
      <storage>
         <type>xcomponent.impl.email.EmailStorage</type>
      </storage>
      <key>
         <parent>INBOX</parent>
      </key>
      <control name=“select”>
   <type>xcomponent.impl.control.html.CheckBoxButton</type>
      <value> </value>
      <header-view>CheckBoxButton<header-view>
      <data-view>CheckBoxButton</data-view>
   </control>
   <sort-by>3</sort-by>
   <data>
</component>
<component name=“EmailMessage”>
   <type>xcomponent.impl.html.ServletComponent</type>
   <component-view>VerticalListView</component-view>
   <data>
      <field name=“col1”>
         <value>Subject</value>
         <data-source>
         <columm>message_content_subject</column>
         </data-source>
         <data-view>TextView</data-view>
         <header-view>LabelTextView</header-view>
      </field>
      <field name=“col2”>
         <value>From</value>
         <data-source>
         <column>message_content_senders</column>
         </data-source>
         <data-view>TextView</data-view>
         <header-view>LabelTextView</header-view>
      </field>
      <field name=“col3”>
         <value>To</value>
         <data-source>
         <column>message_content_recipients_to</column>
         </data-source>
         <data-view>TextView</data-view>
         <header-view>LabelTextView</header-view>
      </field>
      <field name=“col4”>
         <value>CC</value>
         <data-source>
         <column>message_content_recipients_cc</column>
         </data-source>
         <data-view>TextView</data-view>
         <header-view>LabelTextView</header-view>
      </field>
      <field name=“col5”>
         <value>Time Received</value>
         <data-source>
         <column>message_content_rec_date</column>
         </data-source>
         <data-view>TimeView</data-view>
         <header-view>LabelTextView</header-view>
      </field>
      <field name=“col6”>
         <value>Message</value>
         <data-source>
         <column>message_content_body</column>
         </data-source>
         <data-view>MimetypeView</data-view>
      </field>
      <key>
         <parent>INBOX</parent>
      </key>
   </data>
</component>
<component name=“Actions”>
   <type>xcomponent.impl.html.ServletComponent</type>
   <component-view>VerticalListView</component-view>
   <data>
      <field name=“col1”>
         <value>Check Mail</value>
         <data-view>TextView</data-view>
         <data-event>TYPE_URL</data-event>
      </field>
      <field name=“col2”>
         <value>Compose</value>
         <data-view>TextView</data-view>
         <data-event>TYPE_URL</data-event>
      </field>
      <field name=“col3”>
         <value>Create New Folder</value>
         <data-view>TextView</data-view>
         <data-event>TYPE_URL</data-event>
      </field>
      <field name=“col3”>
         <value>Remove Folders</value>
         <data-view>TextView</data-view>
         <data-event>TYPE_URL</data-event>
      </field>
      <field name=“col5”>
         <value>Logout</value>
         <data-view>TextView</data-view>
         <data-event>TYPE_URL</data-event>
      </field>
      <storage>
         <type>xcomponent.impl.SimpleDataStorage</type>
      </storage>
   </data>
</component>
<component name=“Attachment”>
   <type>xcomponent.impl.html.ServletComponent</type>
   <data>
      <field name=“col1”>
         <value>Attachment</value>
         <data-source>
         <column>message_content_attachment</column>
         </data-source>
         <header-view>TextView</header-view>
         <data-view>FileInput</data-view>
      </field>
      <storage>
         <type>xcomponent.impl.email.EmailStorage</type>
      </storage>
      <key>
         <parent>INBOX</parent>
      </key>
   </data>
</component>
<component name=“FileUpload”>
   <type>xcomponent.impl.html.ServletComponent</type>
   <component-view>FileInputView</component-view>
   <data>
      <field name=“file1”>
         <value>File #1</value>
         <header-view>TextView</header-view>
         <data-view>FileInput</data-view>
      </field>
      <field name=“file2”>
         <value>File #2</value>
         <header-view>TextView</header-view>
         <data-view>FileInput</data-view>
      </field>
      <field name=“file3”>
         <value>File #3</value>
         <header-view>TextView</header-view>
         <data-view>FileInput</data-view>
      </field>
      <storage>
         <type>xcomponent.impl.html.FileUploadStorage</type>
         <repository-path>D:/Documents and Settings/Jordan/Desktop/upload</repository-path>
      </storage>
   </data>
</component>
<component name=“WriteEmail”>
   <type>xcomponent.impl.html.ServletComponent</type>
   <component-view>TextInputView</component-view>
   <data>
      <field name=“From”>
         <value>From</value>
         <data-view>TextView</data-view>
         <header-view>TextView</header-view>
      </field>
      <field name=“To”>
         <value>To</value>
         <data-view>ComposeTextInput</data-view>
         <header-view>TextView</header-view>
         <header-event>TYPE_SUBMIT_NO_ACTION</header-event>
      </field>
      <field name=“Cc”>
         <value>Cc</value>
         <data-view>ComposeTextInput</data-view>
         <header-view>TextView</header-view>
         <header-event>TYPE_SUBMIT_NO_ACTION</header-event>
      </field>
      <field name=“Bcc”>
         <value>Bcc</value><data-view>ComposeTextInput</data-view>
         <header-view>TextView</header-view>
         <header-event>TYPE_SUBMIT_NO_ACTION</header-event>
      </field>
      <field name=“Subject”>
         <value>Subject</value>
         <data-view>ComposeTextInput</data-view>
         <header-view>TextView</header-view>
      </field>
      <field name=“Attachments”>
         <value>Attachments</value>
         <header-view>TextView</header-view>
         <data-view>TextView</data-view>
         <header-event>TYPE_SUBMIT_NO_ACTION</header-event>
      </field>
      <field name=“Body”>
         <value></value>
         <data-view>TextAreaInput</data-view>
         <header-view>TextView</header-view>
      </field>
      <field name=“SaveSent”>
         <value>Save Sent Message</value>
         <data-view>TextView</data-view>
         <header-view>TextView</header-view>
         <data-event>TYPE_SELECT</data-event>
      </field>
      <storage>
         <type>xcomponent.impl.email.EmailStorage</type>
         <host>localhost</host>
      </storage>
      <build-stub>true</build-stub>
   </data>
   <action>
      <type>xcomponent.impl.email.SendMessageAction</type>
      <input-columns>0,1,6,2,3,4,5</input-columns>
   </action>
</component>
<component name=“CreateFolder”>
   <type>xcomponent.impl.html.ServletComponent</type>
   <component-view>TextInputView</component-view>
   <data>
      <field name=“col1”>
         <value>Folder Name</value>
         <header-view>TextView</header-view>
         <data-view>FolderNameInput</data-view>
         </field>
         <storage>
         <type>xcomponent.impl.email.EmailStorage</type>
         <host>localhost</host>
         </storage>
         <build-stub>true</build-stub>
      </data>
      <action>
         <type>xcomponent.impl.email.CreateFolderAction</type>
         <input-columns>0</input-columns>
      </action>
</component>
<component name=“AddressList”>
   <type>xcomponent.impl.html.ServletComponent</type>
   <component-view>TableView</component-view>
   <data>
      <field name=“col1”>
         <value>To</value>
         <data-view>TextView</data-view>
         <header-view>TextView</header-view>
         <data-event>TYPE_SELECT</data-event>
      </field>
      <field name=“col2”>
         <value>CC</value>
         <data-view>TextView</data-view>
         <header-view>TextView</header-view>
         <data-event>TYPE_SELECT</data-event>
      </field>
      <field name=“col3”>
         <value>BCC</value>
         <data-view>TextView</data-view>
         <header-view>TextView</header-view>
         <data-event>TYPE_SELECT</data-event>
      </field>
      <field name=“col4”>
         <value>First Name</value>
         <data-source>
         <column>name_first</column>
         <table>user_info</table>
         </data-source>
         <data-view>TextView</data-view>
         <header-view>TextView</header-view>
      </field>
      <field name=“col5”>
         <value>Last Name</value>
         <data-source>
         <column>name_last</column>
         <table>user_info</table>
         </data-source>
         <data-view>TextView</data-view>
         <header-view>TextView</header-view>
      </field>
      <field name=“col6”>
         <value>E-mail</value>
         <data-source>
         <column>email 1</column>
         <table>user_info</table>
         </data-source>
         <data-view>TextView</data-view>
         <header-view>TextView</header-view>
      </field>
      <storage>
         <type>xcomponent.impl.sql.SqlDataStorage</type>
      </storage>
      <sort-by>3</sort-by>
   </data>
</component>
<view name=“TableView”>
   <type>xcomponent.impl.view.html.JspListView</type>
   <jsp-file>/jsp/TableView.jsp</jsp-file>
   <style name=“stripe-color”>#E2E1E4</style>
   <style name=“header-color”>#A7DBC5</style>
   <style name=“class”>list</style>
   <items-per-page>20</items-per-page>
</view>
<view name=“MessageView”>
   <type>xcomponent.impl.view.html.JspComponentView</type>
   <jsp-file>/jsp/MessageView.jsp</jsp-file>
</view>
<view name=“MsgListView”>
   <type>xcomponent.impl.view.html.JspListView</type>
   <jsp-file>/jsp/MsgListView.jsp</jsp-file>
   <items-per-page>10</items-per-page>
</view>
<view name=“ListView”>
   <type>xcomponent.impl.view.html.JspListView</type>
   <jsp-file>/jsp/ListView.jsp</jsp-file>
</view>
<view name=“VerticalListView”>
   <type>xcomponent.impl.view.html.JspListView</type>
   <jsp-file>/jsp/VerticalListView.jsp</jsp-file>
</view>
<view name=“MsgInputView”>
   <type>xcomponent.impl.view.html.JspComponentView</type>
   <jsp-file>/jsp/MsgInputView.jsp</jsp-file>
   <!--style name=“vertical”>y</style-->
</view>
<view name=“BoldTextView”>
   <type>xcomponent.impl.view.html.JspView</type>
   <jsp-file>/jsp/TextView.jsp</jsp-file>
   <style name=“font”>bold</style>
</view>
<view name=“LabelTextView”>
   <type>xcomponent.impl.view.html.JspView</type>
   <jsp-file>/jsp/TextView.jsp</jsp-file>
   <style name=“font”>bold</style>
   <style name=“class”>label</style>
</view>
<view name=“BoldTimeView”>
   <type>xcomponent.impl.view.html.JspView</type><jsp-file>/jsp/InputView.jsp</jsp-file>
   <style name=“font”>bold</style>
</view>
<view name=“TextView”>
   <type>xcomponent.impl.view.html.JspView</type>
   <jsp-file>/jsp/TextView.jsp</jsp-file>
</view>
<view name=“SubjectView”>
   <type>xcomponent.impl.view.html.JspView</type>
   <jsp-file>/jsp/TextView.jsp</jsp-file>
   <style name=“null-text”>none</style>
</view>
<view name=“LoginTextView”>
   <type>xcomponent.impl.view.html.JspView</type>
   <jsp-file>/jsp/TextView.jsp</jsp-file>
   <style name=“class”>login</style>
</view>
<view name=“IconView”>
   <type>xcomponent.impl.view.html.JspView</type>
   <jsp-file>/jsp/IconView.jsp</jsp-file>
   <style name=“multipart/mixed”>images/clip.gif</style>
</view>
<view name=“TextInput”>
   <type>xcomponent.impl.view.html.JspView</type>
   <jsp-file>/jsp/TextInput.jsp</jsp-file>
</view>
<view name=“ComposeTextInput”>
   <type>xcomponent.impl.view.html.JspView</type>
   <jsp-file>/jsp/TextInput.jsp</jsp-file>
   <style name=“len”>50</style>
</view>
<view name=“NameTextInput”>
   <type>xcomponent.impl.view.html.JspView</type>
   <jsp-file>/jsp/TextInput.jsp</jsp-file>
   <style name=“len”>30</style>
   <style name=“maxlen”>30</style>
</view>
<view name=“NameTextInput2”>
   <type>xcomponent.impl.view.html.JspView</type>
   <jsp-file>/jsp/TextInput.jsp</jsp-file>
   <style name=“len”>50</style>
   <style name=“maxlen”>50</style>
</view>
<view name=“EmailTextInput”>
   <type>xcomponent.impl.view.html.JspView</type>
   <jsp-file>/jsp/TextInput.jsp</jsp-file>
   <style name=“len”>40</style>
   <style name=“maxlen”>40</style>
</view>
<view name=“UserNameInput”>
   <type>xcomponent.impl.view.html.JspView</type>
   <jsp-file>/jsp/TextInput.jsp</jsp-file>
   <style name=“len”>15</style>
   <style name=“minlen”>3</style>
   <style name=“maxlen”>15</style>
</view>
<view name=“TimeView”>
   <type>xcomponent.impl.view.html.JspView</type>
   <jsp-file>/jsp/TimeView.jsp</jsp-file>
</view>
<view name=“SingleObjectView”>
   <type>xcomponent.impl.view.html.JspComponentView</type>
   <jsp-file>/jsp/SingleObjectView.jsp</jsp-file>
</view>
<view name=“MimetypeView”>
   <type>xcomponent.impl.view.html.JspView</type>
   <jsp-file>/jsp/MimetypeView.jsp</jsp-file>
</view>
<view name=“PasswordInput”>
   <type>xcomponent.impl.view.html.JspView</type>
   <jsp-file>/jsp/TextInput.jsp</jsp-file>
   <style name=“password”>y</style>
</view>
<view name=“TextAreaInput”>
   <type>xcomponent.impl.view.html.JspView</type>
   <jsp-file>/jsp/TextAreaInput.jsp</jsp-file>
</view>
<view name=“TextInputView”>
   <type>xcomponent.impl.view.html.JspComponentView</type>
   <jsp-file>/jsp/TextInputView.jsp</jsp-file>
</view>
<view name=“FileInputView”>
   <type>xcomponent.impl.view.html.JspComponentView</type>
   <jsp-file>/jsp/TextInputView.jsp</jsp-file>
   <style name=“file-upload”>y</style>
</view>
<view name=“LoginView”>
   <type>xcomponent.impl.view.html.JspComponentView</type>
   <jsp-file>/jsp/LoginView.jsp</jsp-file>
</view>
<view name=“RegisterView”>
   <type>xcomponent.impl.view.html.JspComponentView</type>
   <jsp-file>/jsp/RegisterView.jsp</jsp-file>
</view>
<view name=“RadioButton”>
   <type>xcomponent.impl.view.html.JspControlView</type>
   <jsp-file>/jsp/RadioButton.jsp</jsp-file>
</view>
<view name=“CheckBoxButton”>
   <type>xcomponent.impl.view.html.JspControlView</type>
   <jsp-file>/jsp/CheckBoxButton.jsp</jsp-file>
</view>
<view name=“FileInput”>
   <type>xcomponent.impl.view.html.JspView</type>
   <jsp-file>/jsp/FileInput.jsp</jsp-file>
   <style name=“len”>50</style>
</view>
<view name=“SizeView”>
   <type>xcomponent.impl.view.html.JspView</type>
   <jsp-file>/jsp/TextView.jsp</jsp-file>
   <formatter>
      <type>xcomponent.impl.view.IntegerFormatter</type>
      <base>K</base>
   </formatter>
</view>
<view name=“ListBoxView”>
   <type>xcomponent.impl.view.html.JspComponentView</type>
   <jsp-file>/jsp/ListBoxView.jsp</jsp-file>
</view>
<view name=“FolderNameInput”>
   <type>xcomponent.impl.view.html.JspView</type>
   <jsp-file>/jsp/TextInput.jsp</jsp-file>
   <style name=“len”>30</style>
</view>
</components>

The foregoing description of one or more embodiments has been presented for purposes of illustration and description, and is not intended to be exhaustive or to limit the invention to the precise form or methods disclosed. Rather, it is intended that the scope of the invention not be limited by the specification, but be defined by the claims set forth below.

What is claimed is:

1. An application framework comprising:
a view object configured to display data on a user interface;
a data model object including a matrix of data objects corresponding to the data and accessible by the view object; and
a data storage object configured to retrieve the data from a data storage and to map the data to the data model object.

2. The application framework of claim 1, wherein the data is designated for retrieval by a key tag whose value is set at run-time.

3. The application of claim 1, wherein the data storage object maps the retrieved data to the data model object, in an order determined by the data model object.

4. The application framework of claim 3, wherein the order corresponds to an arrangement of the matrix.

5. The application framework of claim 1, wherein at least one of the data objects comprises a second matrix of data objects.

6. The application framework of claim 1, wherein one or more of the data objects are selected from a group consisting of a text object, a picture object, a video object, or an audio object.

7. The application framework of claim 1, wherein the data storage comprises one or more data containers.

8. The application framework of claim 1, wherein the one or more data containers are located on one or more computer readable drives.

9. The application framework of claim 1, wherein the data model comprises at least one action object.

10. The application framework of claim 9, wherein the action object is a login object.

11. The application framework of claim 1, further comprising a Uniform Resource Locator (URL) handler to process requests from the view object and to update the data model object as necessary.

12. The application framework of claim 9, further comprising a component definition file which defines at least one relationship among the view object, the data model object, the data storage object, and/or the action object.

13. The application framework of claim 12, wherein the component definition file is written in XML format.

14. A method, comprising:
coding a data model object that includes a matrix of data objects having one or more standardized properties; and
coding a data storage object that retrieves data from a data storage and passes the retrieved data to the data model object in an order specified by the data model object.

15. The method of claim 14, further comprising:
coding one or more software objects based on assumptions made about the one or more standardized properties of the data model object.

16. The method of claim 15, wherein one of the one or more software objects is at least one user interface object.

17. The method of claim 16, wherein coding one of the user interface object comprises formatting one or more data views to display text, video, audio, and/or picture data.

18. The method of claim 17, wherein coding at least one user interface object further comprises coding destination and value information.

19. The method of claim 18, wherein coding the destination and value information comprises specifying one or more of the following:
a data container component that contains the data;
the data's coordinates in the matrix of data objects;
a value of the data, and
an event ID that references a lookup key in an event matter table to permit selection of a desired destination record.

20. The method of claim 14, wherein coding the data model object that includes a matrix of data objects having one or more standardized properties comprises coding at least one of the data objects to include a second matrix of data objects.

21. The method of claim 14, further comprising coding one or more action objects associated with the data model object.

22. The method of claim 14, further comprising coding or more transformer objects associated with the data model object, wherein the one or more transformer objects change corresponding one or more values of data.

23. The method of claim 14, further comprising coding one or more validator objects associated with one or more of the data model object and the user interface object.

24. A method, comprising:
receiving user input and requesting one or more pieces of data;
accessing a data storage to retrieve the requested one or more pieces of data; and
mapping the retrieved, requested one or more pieces of data to a standardized matrix of data objects independent of a type of data storage accessed.

25. The method of claim 24, further comprising displaying the mapped one or more pieces of data on a user interface.

26. The method of claim 25, further comprising validating one or more of the one or more pieces of requested data.

27. The method of claim 25, further comprising performing a pre-determined action associated with the retrieval of the requested one or more pieces of data.

28. The method of claim 27, wherein the pre-determined action is a login action.

29. The method of claim 25, further comprising performing a pre-determined transformer action associated with the retrieval of the requested one or more pieces of data.
